(19) United States
(12) Patent Application Publication
(10) Pub. No.: US 2026/0361086 A1
(43) Pub. Date: Nov. 12, 2026

(54) HOUSEHOLD POWER SUPPLY NETWORK, PARALLEL CONTROL METHOD, AND DISTRIBUTED ENERGY STORAGE SYSTEM

(71) Applicant: SHENZHEN HELLO TECH ENERGY CO., LTD, Shenzhen (CN)

(72) Inventors: Shaohong DAI, Shenzhen (CN); Gaosong SHEN, Shenzhen (CN)

(21) Appl. No.: 19/726,877

(22) Filed: Jun. 30, 2026

Related U.S. Application Data
(63) Continuation of application No. PCT/CN2025/101607, filed on Jun. 18, 2025.

(30) Foreign Application Priority Data
May 26, 2025 (CN) 202510687465.7
May 26, 2025 (CN) 202510687469.5
May 26, 2025 (CN) 202510689973.9
May 26, 2025 (CN) 202510690051.X

(51) Int. Cl. H02J 3/32; H02J 3/0073; H02J 7/06; H02J 9/06; H02J 13/18; H02J 105/12

(52) U.S. Cl. CPC H02J 3/32; H02J 3/0073; H02J 7/06; H02J 9/068; H02J 13/18; H02J 2105/12

(57) ABSTRACT

Provided is a household power supply network. The household power supply network includes a household power distribution device and an energy storage device. The household power distribution device includes a utility power input terminal, a household grid terminal, and a power distribution management module. The utility power input terminal is configured to be connected to a utility power. The household grid terminal is configured to be connected to a household grid. The household grid is connectable to one of the utility power or the energy storage device. The power distribution management module includes a main output line provided with a smart circuit breaker. The smart circuit breaker includes a control module and a main line switch electrically connected to the control module. The main line switch has an end connected to the utility power input terminal and another end connected to the household grid terminal. The control module includes a detection unit configured to detect whether the utility power input terminal loses power and to detect whether the energy storage device is connected to the household grid. The control module is configured to, in response to the detection unit detecting that the utility power input terminal loses power, control the main line switch to be opened, to enable the energy storage device to supply power to the household grid. The control module is configured to, in response to the utility power being normal and the household grid being disconnected from the energy storage device, control the main line switch to be closed, to enable the utility power to supply power to the household grid.

### CROSS-REFERENCE TO RELATED APPLICATION

This application is a continuation of International Application No. PCT/CN 2025/101607, filed on Jun. 18, 2025, which claims priorities to and the benefit of Chinese Patent Applications Nos. 202510687465.7, 202510687469.5, 202510689973.9, and 202510690051.X, filed with China National Intellectual Property Administration on May 26, 2025, the entire contents of which are incorporated herein by reference.

### FIELD

The present disclosure relates to the field of household power supply technologies, and particularly, to a household power supply network, a parallel control method, and a distributed energy storage system.

### BACKGROUND

At present, there are more and more suppliers of portable energy storage devices in the market, and power of products is becoming increasingly large. Merely using them for outdoor power supply would lead to excessively low utilization frequency, resulting in high costs and making the product uneconomical.

In addition, conventional portable energy storage devices only have an off-grid output function. As a result, if the portable energy storage device is used for household electricity or emergency electricity, simultaneous outputs from a utility power and the portable energy storage device will damage household appliances due to a phase difference between their alternating currents when the portable energy storage device is directly connected to a household grid. A conventional approach is to additionally mount a corresponding sub-distribution box for the portable energy storage device. That is, the household grid is configured with both a main distribution box and the sub-distribution box. The main distribution box is connected to the utility power to supply power to a non-critical load in the home. The sub-distribution box can be connected to both the utility power and the portable energy storage device to supply power to a critical load, and is supplied by either the utility power or the portable energy storage device at any time point to avoid a situation where the household appliances are damaged due to the phase difference. It was realized that, this approach makes the entire household grid cumbersome, and increases use costs for consumers. Further, the portable energy storage device is limited to being used at a position of the sub-distribution box, resulting in inconvenience.

In addition, a household distribution box is provided with a circuit breaker. As illustrated in FIG. 1, the circuit breaker includes a switch power supply, a microcontroller unit (MCU), a mechanical switch, and a motor. When the utility power is normal, the switch power supply can receive electric energy provided by utility power to supply power to the microcontroller unit, and the mechanical switch continuously remains in a closed state, in such a manner that the utility power supplies power to the household grid. However, it was also realized that, when the utility power is suddenly cut off, the mechanical switch remains unchanged in the closed state, or when the utility power becomes abnormal, such as when a large current or an arc occurs, the microcontroller unit controls the mechanical switch in the circuit breaker to switch from the closed state to an open state, and when the utility power returns to normal, manually closing the mechanical switch cannot automatically return to the original closed state.

### SUMMARY

In view of the above problems, the present disclosure aims to solve at least one of the problems in the related art to some extent. To this end, an objective of the present disclosure is to provide a household power supply network, a parallel control method, and a distributed energy storage system.

The present disclosure provides a household power supply network. The household power supply network includes: an energy storage device; and a household power distribution device including a utility power input terminal, a household grid terminal, and a power distribution management module. The utility power input terminal is configured to be connected to a utility power. The household grid terminal is configured to be connected to a household grid. The household grid is connectable to one of the utility power or the energy storage device. The power distribution management module includes a main output line provided with a smart circuit breaker. The smart circuit breaker includes a control module and a main line switch electrically connected to the control module, the main line switch having an end connected to the utility power input terminal and another end connected to the household grid terminal. The control module includes a detection unit configured to detect whether the utility power input terminal loses power and to detect whether the energy storage device is connected to the household grid. The control module is configured to, in response to the detection unit detecting that the utility power input terminal loses power, control the main line switch to be opened, to enable the energy storage device to supply power to the household grid. The control module is configured to, in response to the utility power being normal and the household grid being disconnected from the energy storage device, control the main line switch to be closed, to enable the utility power to supply power to the household grid.

The present disclosure further provides a parallel control method, applied in a plurality of energy storage devices, each of the plurality of energy storage devices being the energy storage device in the household power supply network according to the above embodiments. The energy storage device includes an output interface. The energy storage device and remaining energy storage devices of the plurality of energy storage devices are connected in parallel to the household grid through the output interfaces. The household grid is connectable to the utility power and/or the energy storage device. The household grid is provided with a socket. The energy storage device and the remaining energy storage devices are connected in one-to-one correspondence to a plurality of sockets through the output interfaces. The energy storage device is communicatively connected to the remaining energy storage devices. The parallel control method includes: controlling, by the energy storage device serving as a master, an operation mode of the energy storage device based on a state of the utility power, in which the operation mode includes a grid-connected mode and an off-grid mode; in response to the utility power being normal, enabling the energy storage device serving as the master to operate in the grid-connected mode to output an alternating current, to allow each of the remaining energy storage devices serving as slaves to output an alternating current in a grid-connected manner, and to enable the master, the slaves, and the utility power to jointly supply power to the household grid; and in response to the utility power losing power, enabling the energy storage device serving as the master to operate in the off-grid mode to output the alternating current, to allow each of the remaining energy storage devices serving as the slaves to output the alternating current in the grid-connected manner, and to enable the master and the slaves to jointly supply power to the household grid.

The present disclosure further provides a distributed energy storage system. The distributed energy storage system includes: a plurality of energy storage devices, each of the plurality of energy storage devices being the energy storage device in the household power supply network according to the above embodiments. The energy storage device includes an output interface. The plurality of energy storage devices are connected in parallel to the household grid through the output interfaces. The household grid is provided with a plurality of sockets. The plurality of energy storage devices are connected in one-to-one correspondence to the plurality of sockets through the output interfaces. The household grid is connectable to the utility power and/or the energy storage device. The plurality of energy storage devices are communicatively connected with each other. One of the plurality of energy storage devices serves as a master. Remaining energy storage devices of the plurality of energy storage devices serve as slaves. The master is configured to control an operation mode of the master based on a state of the utility power. The operation mode includes a grid-connected mode and an off-grid mode. When the utility power is normal, the master is capable of operating in the grid-connected mode to output an alternating current, and each of the slaves outputs an alternating current in a grid-connected manner, to enable the master, the slaves, and the utility power to jointly supply power to the household grid. When the utility power loses power, the master is capable of operating in the off-grid mode to output the alternating current, and each of the slaves outputs the alternating current in the grid-connected manner, to enable the master and the slaves to jointly supply power to the household grid.

The household power distribution device in the household power supply network of the present disclosure can expand application functions of the energy storage device, in such a manner that the energy storage device not only meets power supply needs for outdoor activities, but can also serve as an emergency power supply when the household grid experiences a power outage. In addition, by adding the control module in the power distribution management module, the household power distribution device of the present disclosure can intelligently control the main line switch to be opened when the utility power loses power. Consequently, the energy storage device connected to the household grid provides emergency power supply to the household grid, without a need to additionally mount a corresponding distribution box for the energy storage device, enabling the energy storage device to be simply and quickly incorporated into household emergency power supply.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings.

FIG. 1 is a schematic structural view of a circuit breaker in a household distribution box in the related art.

FIG. 2 is a schematic structural view of a household power supply network according to some embodiments of the present disclosure.

FIG. 3 is a schematic structural view of a smart circuit breaker of a household power distribution device in a household power supply network according to some embodiments of the present disclosure.

FIG. 4 is a schematic structural view of a household power distribution device in a household power supply network according to some embodiments of the present disclosure.

FIG. 5 is a schematic structural view of communication connections among an energy storage device, a control module, and a mobile terminal according to some embodiments of the present disclosure.

FIG. 6 is a schematic structural view of a connection of an ordinary socket in a household distribution box in the related art.

FIG. 7 is a schematic diagram of a circuit connection when a transfer switch is provided in a smart control socket according to some embodiments of the present disclosure.

FIG. 8 is a schematic structural view showing that a smart control socket is arranged between circuits of a main line switch and a branch line switch in a household power distribution device according to some embodiments of the present disclosure.

FIG. 9 is a schematic structural view showing that a smart control socket is arranged between circuits of a branch line switch and a locally predetermined number of ordinary sockets in a household power distribution device according to some embodiments of the present disclosure.

FIG. 10 is a schematic structural view of a smart control socket according to some embodiments of the present disclosure.

FIG. 11 is a schematic structural view of an internal circuit of a smart control socket according to some embodiments of the present disclosure.

FIG. 12 is a schematic structural view of an internal circuit of a smart control socket according to some embodiments of the present disclosure.

FIG. 13 is a schematic structural view of an internal circuit of a distributed energy storage system according to some embodiments of the present disclosure.

FIG. 14 is a schematic structural diagram of an internal circuit of an energy storage device according to some embodiments of the present disclosure.

FIG. 15 is a schematic flowchart of a parallel control method according to some embodiments of the present disclosure.

FIG. 16 is a schematic flowchart of a parallel control method according to some embodiments of the present disclosure.

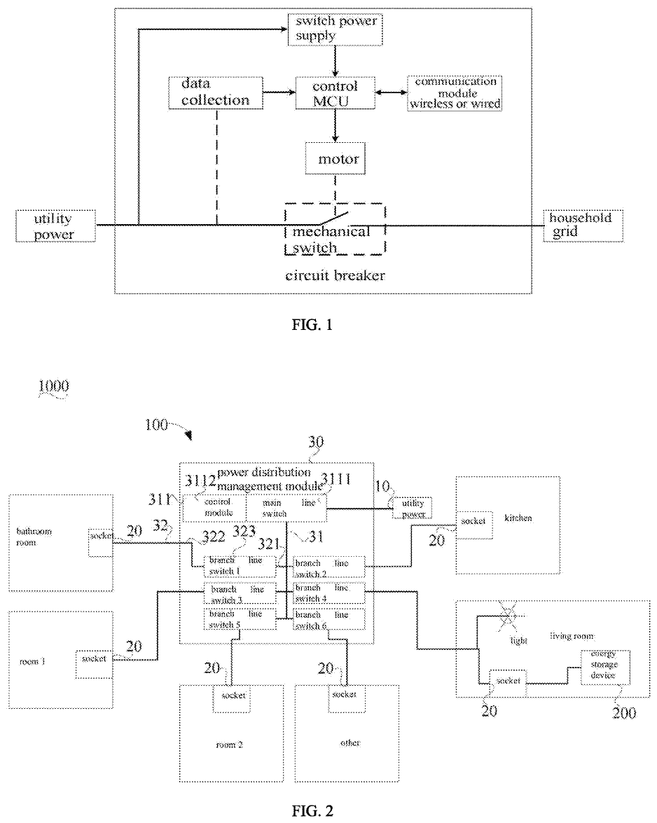

Description of main reference numerals in the accompanying drawings:
household power supply network 1000; distributed energy storage system 2000;
household power distribution device 100, utility power input terminal 10, household grid terminal 20, power distribution management module 30, main output line 31, smart circuit breaker 311, main line switch 3111, control module 3112, detection unit 31121, switch power supply 31122, backup power supply 31123, control unit 31124, driving unit 31125, mechanical transmission unit 311251, mechanical locking unit 311252, first communication unit 31126, output branch line 32, electrical energy input terminal 321, household load access terminal 322, branch line switch 323;
energy storage device 200, second communication unit 210, output interface 220, battery module 230, bidirectional inverter 240, energy storage switch 250, energy storage control module 260;
smart control socket 300, transfer switch 310, first transfer switch 311, second transfer switch 312, third transfer switch 313, energy storage input terminal 320, energy storage output terminal 330, utility power terminal 340, household load terminal 350, energy storage input-output terminal 360;
mobile terminal 400.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the description of the present disclosure, terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, unless otherwise specifically defined.

In the description of the present disclosure, it should be noted that, unless otherwise clearly specified and limited, terms such as “install” and “connect” should be understood in a broad sense. For example, it may be a fixed connection or a detachable connection or connection as one piece; mechanical connection or electrical connection or mutual communication; direct connection or indirect connection through an intermediate; internal communication of two components or the interaction relationship between two components. For those of ordinary skill in the art, the specific meaning of the above-mentioned terms in the present disclosure can be understood according to specific circumstances.

Various embodiments or examples for implementing different structures of the present disclosure are provided below. In order to simplify the description of the present disclosure, components and arrangements of specific examples are described herein. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed arrangements.

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

As illustrated in FIG. 2, the present disclosure provides a household power supply network 1000. The household power supply network 1000 includes a household power distribution device 100 and an energy storage device 200. The household power distribution device 100 includes a utility power input terminal 10, a household grid terminal 20, and a power distribution management module 30.

The utility power input terminal 10 is configured to be connected to utility power. The household grid terminal 20 is configured to be connected to a household grid. The household grid is connectable to one of the utility power or the energy storage device 200.

The power distribution management module 30 includes a main output line 31 provided with a smart circuit breaker 311. The smart circuit breaker 311 includes a control module 3112 and a main line switch 3111 electrically connected to the control module 3112. The main line switch 3111 has an end connected to the utility power input terminal 10 and another end connected to the household grid terminal 20.

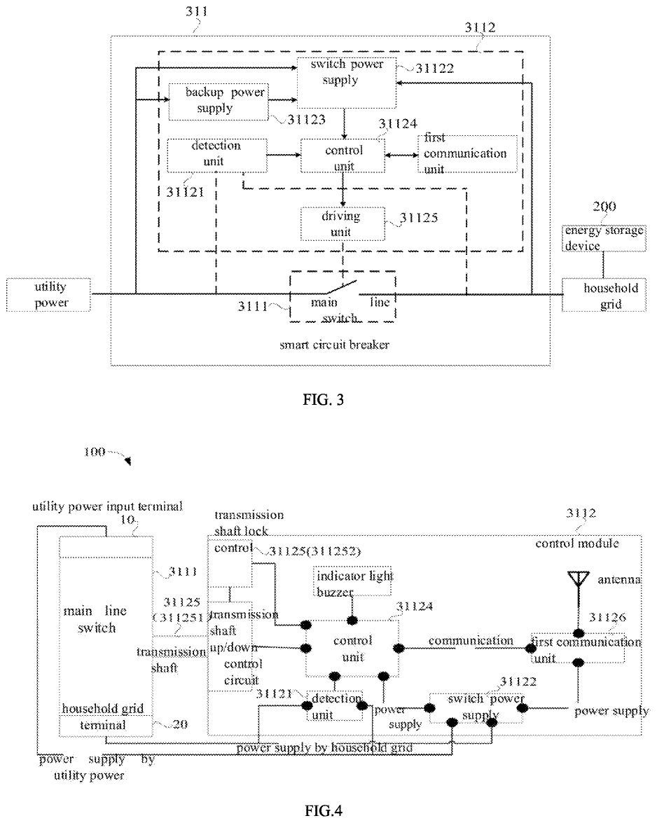

As illustrated in FIG. 3, the control module 3112 includes a detection unit 31121 configured to detect whether the utility power input terminal 10 loses power and to detect whether the energy storage device 200 is connected to the household grid. The control module 3112 is configured to, in response to the detection unit 31121 detecting that the utility power input terminal 10 loses power, control the main line switch 3111 to be opened, to enable the energy storage device 200 to supply power to the household grid. The control module 3112 is configured to, in response to the utility power being normal and the household grid being disconnected from the energy storage device 200, control the main line switch 3111 to be closed, to enable the utility power to supply power to the household grid.

Specifically, as illustrated in FIG. 3, the detection unit 31121 may be directly electrically connected to each of the household grid terminal 20 and the utility power input terminal 10, to detect whether the utility power loses power and whether the energy storage device 200 is connected to the household grid. For example, when the detection unit 31121 detects that the utility power input terminal 10 receives utility power, it indicates that the utility power does not lose power, that is, the utility power is normal. When the detection unit 31121 detects that the utility power input terminal 10 loses power, it indicates that the utility power loses power. When the detection unit 31121 detects that the utility power loses power while the household grid terminal 20 receives power, it indicates that the energy storage device 200 is connected to the household grid. When the detection unit 31121 detects that the utility power loses power while the household grid terminal 20 receives no power, it indicates that the energy storage device 200 is disconnected from the household grid.

In this way, in the present disclosure, by providing the detection unit 31121 in the control module 3112, whether the utility power connected to the household grid loses power and whether the household grid is connected to the energy storage device 200 can be detected.

The main line switch 3111 may be a circuit breaker. That “the main line switch 3111 has an end connected to the utility power input terminal 10 and another end connected to the household grid terminal 20. The control module 3112 is configured to, in response to the utility power being normal and the household grid being disconnected from the energy storage device 200, control the main line switch 3111 to be closed, to enable the utility power to supply power to the household grid” means that the main line switch 3111 may control a connection or a disconnection of a path between the utility power and the household grid. When the main line switch 3111 is closed, the utility power is electrically connected to the household grid, and the household grid is supplied with power through the utility power. When the main line switch 3111 is opened, the utility power is disconnected from the household grid, and the household grid cannot be supplied with power through the utility power in this case.

That “the control module 3112 is configured to, in response to the detection unit 31121 detecting that the utility power input terminal 10 loses power, control the main line switch 3111 to be opened, to enable the energy storage device 200 to supply power to the household grid” means that, when the utility power loses power, the control module 3112 may automatically control the main line switch 3111 to be opened, to enable the utility power to be disconnected from the household grid. That is, when the household grid cannot be supplied with power through the utility power in this case, the control module 3112 may perform a switching to enable the energy storage device 200 to supply power to the household grid.

That is, when the utility power is normal, the household power distribution device 100 of the present disclosure can supply power to the household grid at the household grid terminal 20 through the utility power inputted from the utility power input terminal 10. In addition, when the utility power loses power, the household power distribution device 100 of the present disclosure may perform an intelligent switching, through the control module 3112, to enable the energy storage device 200 to provide emergency power supply to the household grid.

When the utility power is normal and the household grid is disconnected from the energy storage device 200, the control module 3112 controls the main line switch 3111 to be closed, to enable the utility power to supply power to the household grid. That is, the control module 3112 and the main line switch 3111 of the present disclosure can constitute the smart circuit breaker 311. The smart circuit breaker 311 is capable of intelligently and automatically controlling the closing and opening of the main line switch 3111.

That is, the household power distribution device 100 of the present disclosure is provided with the smart circuit breaker 311. In response to the utility power losing power, the main line switch 3111 may be intelligently controlled by the control module 3112 to be opened. In response to the utility power being normal and the household grid being disconnected from the energy storage device 200, the main line switch 3111 may be controlled by the control module 3112 to be closed, to enable the utility power to supply power to the household grid, allowing the main line switch 3111 to automatically restore its original closed state without a need to manually close the main line switch 3111, which is more intelligent.

In this way, the household power distribution device 100 of the present disclosure can expand application functions of the energy storage device 200, in such a manner that the energy storage device 200 not only meets power supply needs for outdoor activities, but also can serve as an emergency power supply when the household grid experiences a power outage. In addition, by adding the control module 3112 into the power distribution management module 30, the household power distribution device 100 of the present disclosure can intelligently control the main line switch 3111 to be opened when the utility power fails. Consequently, the energy storage device 200 connected to an energy storage access terminal 20 provides emergency power supply to the household grid, without a need to additionally provide a corresponding distribution box for the energy storage device 200, enabling the energy storage device 200 to be simply and quickly incorporated into household emergency power supply. Further, in response to the utility power being normal and the household grid being disconnected from the energy storage device 200, the main line switch 3111 is controlled by the control module 3112 to be closed, to enable the utility power to supply power to the household grid, allowing the main line switch 3111 to automatically restore its original closed state without the need to manually close the main line switch 3111, which is more intelligent.

In some embodiments, the control module 3112 includes a switch power supply 31122. The switch power supply 31122 has a first input terminal electrically connected to the utility power input terminal 10 and a second input terminal electrically connected to the household grid terminal 20. The switch power supply 31122 is capable of receiving electrical energy provided by the utility power or the household grid to drive the main line switch 3111 to be opened or closed.

Specifically, when the utility power is normal and the household grid terminal is disconnected from the energy storage device 200, the control module 3112 of the present disclosure may maintain a normal operation through the electrical energy provided by the utility power connected to the utility power input terminal 10, driving and controlling the main line switch 3111 to remain in the closed state. When the utility power loses power and the household grid is connected to the energy storage device 200, the control module 3112 of the present disclosure may also maintain the normal operation through electrical energy provided by the energy storage device 200 connected to the household grid, driving and controlling the main line switch 3111 to remain in an open state. In this way, a power supply circuit of the utility power is prevented from being in parallel with a power supply circuit of the energy storage device 200 at the household grid terminal when the utility power is restored, which can avoid a risk of grid connection.

That is, the switch power supply 31122 may be provided inside the control module 3112. When either the utility power input terminal 10 or the household grid terminal 20 receives power, electrical energy can be automatically provided to the switch power supply 31122, enabling the switch power supply 31122 to start operating. Thus, either the utility power or the household grid can provide the electrical energy required for an operation of an internal circuit of the control module 3112.

In some embodiments, the control module 3112 further includes a switch power supply 31122 and a backup power supply 31123. The backup power supply 31123 has an end connected to the utility power input terminal 10 and another end connected to a third input terminal of the switch power supply 31122. The backup power supply 31123 is configured to be charged by the utility power in response to the utility power being normal, and provide electrical energy to the switch power supply 31122 in response to the utility power losing power, to drive the main line switch 3111 to be opened.

Specifically, the backup power supply 31123 is disposed between the utility power input terminal 10 and the switch power supply 31122. When the utility power is present, the utility power can charge the backup power supply 31123, and the utility power can also supply power to the switch power supply 31122, enabling the switch power supply 31122 to drive and control the main line switch 3111 to be closed. When the utility power loses power, in a case where the main line switch 3111 is in the closed state, the electrical energy provided to the switch power supply 31122 by the backup power supply 31123 can enable the switch power supply 31122 to drive and control the main line switch 3111 to be opened, achieving a self-recovery opening function of the main line switch 3111.

Subsequent to the main line switch 3111 being controlled to be opened through the electrical energy provided by the backup power supply 31123, when the energy storage device 200 is connected to the household grid, an alternating-current output function of the energy storage device 200 can be enabled. In addition, through a socket in any room of the household grid, for example, by connecting the energy storage device 200 to one socket in the living room or to a socket in another room, a connection position can be freely determined based on user convenience or power usage, to provide an alternating current from the energy storage device 200 to the household grid, for supplying an alternating current to the entire household. The socket may be configured as a special socket configured for a power supply connection of the energy storage device 200, i.e., the smart control socket 300 described below.

In some embodiments, the backup power supply 31123 includes a battery or a capacitor.

That is, the backup power supply 31123 of the present disclosure may use a rechargeable battery such as a lithium battery as an energy storage element, or may use a supercapacitor, such as an electric double-layer capacitor, as an energy storage element, to pre-store the electrical energy required for driving and controlling the main line switch 3111 to be opened.

In some embodiments, the control module 3112 further includes a control unit 31124 electrically connected to the detection unit 31121. The detection unit 31121 is configured to detect whether the utility power input terminal 10 loses power and to detect whether the energy storage device 200 is connected to the household grid. The control unit 31124 is configured to: in response to a determination by the detection unit 31121 that the utility power input terminal 10 loses power, control the main line switch to be opened, and in response to a determination by the detection unit 31121 that the utility power is normal and the household grid is disconnected from the energy storage device 200, control the main line switch 3111 to be closed, to enable the utility power to supply power to the household grid.

Specifically, the detection unit 31121 may be directly electrically connected to each of the household grid terminal 20 and the utility power input terminal 10, to detect whether the utility power loses power and whether the energy storage device 200 is connected to the household grid.

For example, when the detection unit 31121 detects that the utility power input terminal 10 receives power, it indicates that the utility power does not lose power, that is, the utility power is normal. When the detection unit 31121 detects that the utility power input terminal 10 loses power, it indicates that the utility power loses power. When the detection unit 31121 detects that the utility power loses power while the household grid terminal 20 receives power, it indicates that the energy storage device 200 has been connected to the household grid. When the detection unit 31121 detects that the utility power loses power while the household grid terminal 20 has no power, it indicates that the energy storage device 200 is disconnected from the household grid.

In this way, in the present disclosure, by providing the detection unit 31121 in the control module 3112, whether the utility power connected to the household grid loses power and whether the household grid terminal is connected to the energy storage device 200 can be detected.

In some embodiments, the control unit 31124 is configured to, in response to the utility power input terminal 10 being in a power-loss state and the energy storage device 200 being connected to the household grid, control the main line switch 3111 to remain in an open state; or the control unit 31124 is configured to, in response to the household grid being disconnected from the energy storage device 200 and the utility power input terminal 10 being in a powered state, control the main line switch 3111 to be closed.

Specifically, when the utility power input terminal 10 is in the power-loss state and the energy storage device 200 is connected to the household grid, the control unit 31124 controls the main line switch 3111 to remain in the open state. In this way, the power supply circuit of the utility power is prevented from being in parallel with the power supply circuit of the energy storage device 200 at the household grid terminal 20 when the utility power is restored, which can avoid the risk of grid connection.

When the household grid is disconnected from the energy storage device 200 and the utility power input terminal 10 is in the powered state, controlling the main line switch 3111 to be closed can restore power supply to the household grid through the utility power.

As illustrated in FIG. 3, in some embodiments, the control module 3112 further includes a driving unit 31125 connected to the main line switch 3111. The control unit 31124 is connected to each of the detection unit 31121 and the driving unit 31125, and is configured to, in response to the detection unit 31121 detecting that the utility power input terminal 10 loses power and the energy storage device 200 being connected to the household grid, control the driving unit 31125 to operate to open the main line switch 3111, and control the energy storage device 200 to supply power to the household grid.

Specifically, the driving unit 31125 may be a motor or other driving devices, which is not limited herein.

When the utility power experiences a power outage, the detection unit 31121 may control the driving unit 31125 to drive the main line switch 3111 to be opened, as long as the detection unit 31121 detects the power outage of the utility power, in such a manner that the household grid is disconnected from the utility power, making the household grid an independent module. In this case, if the user has the energy storage device 200 at home, the user may connect the energy storage device 200 to the household grid and enable the alternating-current output function of the energy storage device 200. A manner of connecting the energy storage device 200 to the household grid may be to insert the energy storage device 200 into any socket used in the household, thereby connecting the energy storage device to the household grid. That is, in the present disclosure, the alternating current of the energy storage device 200 can be provided to the household grid through a socket in any room in the household, supplying the alternating current to the entire household.

For example, as illustrated in FIG. 2, the energy storage device 200 may be connected to one socket in the living room, or to a socket in another room. In the present disclosure, the connection position of the energy storage device 200 may be determined based on user convenience, or the connection position of the energy storage device may be determined based on maximum power of the energy storage device 200 used.

In this way, in the present disclosure, when the detection unit 31121 detects that the utility power input terminal 10 loses power and the energy storage device 200 is connected to the household grid, the driving unit 31125 may be controlled by the control unit 31124 to operate to open the main line switch 3111, and the energy storage device 200 may be controlled by the control unit 31124 to supply power to the household grid. That is, switching of a power supply source for the household grid can be realized through the control module 3112 formed by the control unit 31124, the detection unit 31121, and the driving unit 31125.

As illustrated in FIG. 4, in some embodiments, the driving unit 31125 includes a mechanical transmission unit 311251 and a mechanical locking unit 311252 connected to the mechanical transmission unit 311251. The mechanical transmission unit 311251 and the mechanical locking unit 311252 are connected to the control unit 31124. The control unit 31124 is further configured to, in response to the utility power input terminal 10 losing power, control the mechanical transmission unit 311251 to move to open the main line switch 3111, and control, within a predetermined duration from a time point at which the energy storage device 200 starts supplying power to the household grid, the mechanical locking unit 311252 to lock the mechanical transmission unit 311251 to maintain the main line switch 3111 in an open state.

Specifically, the mechanical transmission unit 311251 may be a transmission shaft. Correspondingly, the control module 3112 further includes a transmission shaft control circuit connecting the control unit 31124 and the transmission shaft. When the utility power experiences the power outage, the detection unit 31121 may control the transmission shaft to rotate through the transmission shaft control circuit, as long as the detection unit 31121 detects the power outage of the utility power, in such a manner that the main line switch 3111 is controlled to be opened. In this way, the household grid is disconnected from the utility power, making the household grid the independent module.

The predetermined duration may be, for example, 0 s, 0.1 s, 0.2 s, 0.3 s, 0.4 s, 0.5 s, 0.6 s, 0.7 s, 0.8 s, or 1 s, which is not limited herein. When the predetermined duration is 0 s, the control unit 31124 may control the mechanical locking unit 311252 to lock the mechanical transmission unit 311251, in response to the utility power input terminal 10 losing power and the energy storage device 200 starting supplying power to the household grid, to maintain the main line switch 3111 in the open state. When the predetermined duration is 0.1 s, the control unit 31124 may control the mechanical locking unit 311252 to lock the mechanical transmission unit 311251 in response to the utility power losing power and within 0.1 s from the time point at which the energy storage device 200 starts supplying power to the household grid, to maintain the main line switch 3111 in the open state.

It should be understood that, when the utility power experiences the power outage and at an instant when the energy storage device 200 provides the alternating current to the household grid, or within the predetermined duration from a time point at which the energy storage device 200 provides the alternating current to the household grid, the control unit 31124 controls the mechanical locking unit 311252 to lock the mechanical transmission unit 311251. The mechanical locking unit 311252 can lock the mechanical transmission unit 311251 in a rotation state in such a way that the main line switch 3111 is in the open state. In this way, the user is prevented from accidentally actuating the main line switch 3111 to unexpectedly connect the household grid to the utility power while the energy storage device 200 supplying power to the household grid, which would avoid electrical hazards caused by a failure of the energy storage device 200.

In detail, when the main line switch 3111 is opened and subsequent to the energy storage device 200 supplying power to the household grid, the detection unit 31121 may collect current values of both the utility power input terminal 10 and the household grid terminal 20, and the control unit 31124 determines based on the current values that whether both the utility power input terminal 10 and the household grid terminal 20 receive power.

When the detection unit 31121 detects that the current value of the utility power input terminal 10 is 0, and the detection unit 31121 detects that the current value of the household grid terminal 20 is not 0 or a relatively large value, the control unit 31124 may determine that in this case the utility power input terminal 10 receives no power, the utility power is still in the power-loss state, and the household grid terminal 20 receives power. Therefore, the control unit 31124 may control the mechanical locking unit 311252 to lock the mechanical transmission unit 311251 to maintain the main line switch 3111 in the open state, and record that the household power distribution device 100 is in an energy storage emergency backup state in this case.

In the case where the current value of the utility power input terminal 10 detected by the detection unit 31121 is not 0 or is a relatively large value, and the current value of the household grid terminal 20 detected by the detection unit 31121 is not 0 or is a relatively large value, the control unit 31124 may determine that in this case the utility power input terminal 10 receives power, the utility power is in a powered state, and the household grid terminal 20 receives power. Therefore, the control unit 31124 may control the mechanical locking unit 311252 to lock the mechanical transmission unit 311251 to maintain the main line switch 3111 in the open state, and prompt the user that the utility power is restored. In this way, it is convenient for the user to timely disable the alternating-current output function of the energy storage device 200 or to disconnect the energy storage device 200 from the energy storage access terminal 30, and operate, manually or through an application (APP) on a mobile terminal 400, to close the main line switch 3111 so that the household grid is supplied power by the utility power.

In the case where the current value of the utility power input terminal 10 detected by the detection unit 31121 is not 0 or is a relatively large value, and the current value of the household grid terminal 20 detected by the detection unit 31121 is 0, the control unit 31124 may determine that in this case the utility power input terminal 10 receives power, the utility power is in the powered state, and the household grid terminal 20 has no power, it indicates that the alternating-current output function of the energy storage device 200 is disabled or the energy storage device 200 is disconnected from the energy storage access terminal 30, and thus the energy storage device 200 stops supplying power to the household grid. Therefore, in this case, the control unit 31124 may directly control the main line switch 3111 to be closed, to resume supplying power to the household grid by the utility power.

As illustrated in FIG. 3 and FIG. 4, the control unit 31124 is electrically connected to a first terminal of the detection unit 31121, a second terminal of the detection unit 31121 is electrically connected to the household grid terminal 20, a third terminal of the detection unit 31121 is electrically connected to the utility power input terminal 10, and the detection unit 31121 is configured to collect an electrical signal of each of the household grid terminal 20 and the utility power input terminal 10. The control unit 31124 is configured to determine, based on the electrical signals, whether the utility power input terminal 10 receives power and whether the household grid terminal 20 receives power, and control the mechanical locking unit 311252 to lock or unlock the mechanical transmission unit 311251, or control the main line switch 3111 to be closed or opened.

Specifically, the detection unit 31121 may be configured to collect the electrical signal of each of the household grid terminal 20 and the utility power input terminal 10, and transmit the sampled electrical signals to the control unit 31124, in such a manner that the control unit 31124 may determine based on the electrical signals, whether the utility power input terminal receives power and whether the household grid terminal 20 receives power, and control the main line switch 3111 to be closed or opened. The electrical signal may be a current signal or a voltage signal, which is not limited herein.

In detail, as illustrated in FIG. 3 and FIG. 4, when the current value of the utility power input terminal 10 detected by the detection unit 31121 is not 0 or is a relatively large value, and the household grid is disconnected from the energy storage device 200, the control unit 31124 may determine that the utility power input terminal 10 receives power, i.e., determine that the utility power is normal, and thus may control the main line switch 3111 to be closed, to enable the utility power to supply power to the household grid.

When the current value of the utility power input terminal 10 detected by the detection unit 31121 is 0, and the household grid is connected to the energy storage device 200, the control unit 31124 may determine that the utility power input terminal 10 is disconnected from the utility power, i.e., the utility power loses power, and thus may control the main line switch 3111 to be opened, to enable the energy storage device 200 to supply power to the household grid.

That is, with the control module 3112 of the household power distribution device 100 of the present disclosure, the electrical signal of each of the utility power input terminal 10 and the household grid terminal 20 may be collected in real time by the detection unit 31121, in such a manner that the control unit 31124 determines whether each of the utility power and the household grid has power. Accordingly, the corresponding intelligent control is performed, bringing convenience to the user's life. In addition, convenience and safety of the user in using the energy storage device 200 for household emergency backup power can be ensured, which can avoid abnormal conditions that would cause a short circuit in a circuit formed by the energy storage device 200 and the utility power, ensuring safety of the user in using the energy storage device 200 for emergency power supply.

In this way, when the utility power experiences the power outage and at the instant when the energy storage device 200 provides the alternating current to the household grid or within the predetermined duration from the time point at which the energy storage device 200 provides the alternating current to the household grid, the household power distribution device 100 of the present disclosure may control, through the control unit 31124, the mechanical locking unit 311252 to lock the mechanical transmission unit 311251, which can avoid a circuit failure when the energy storage device 200 supplies power to the household grid, ensuring circuit safety when the energy storage device 200 supplies power.

In some embodiments, the control module 3112 is communicatively connected to the energy storage device 200, and is configured to, in response to the utility power losing power and the main line switch 3111 being open, control the energy storage device 200 to supply power to the household grid.

That is, the control module 3112 may be configured to detect in real time whether the household grid is connected to the energy storage device 200. The control module 3112 may establish, when the household grid is connected to the energy storage device 200, a communicative connection with the connected energy storage device 200.

In this way, in the present disclosure, when the utility power loses power and the main line switch 3111 is opened, the control module 3112 may establish the communication connection with the energy storage device 200 connected to the household grid. For example, the control module 3112 may trigger and control, through transmitting a wireless communication signal to the energy storage device 200, the energy storage device 200 to enable the alternating-current output function for outputting the alternating current. In this way, intelligent control for emergency power supply to the household grid using the energy storage device 200 is achieved by the control module 3112.

As illustrated in FIG. 5, in some embodiments, each of the control module 3112 and the energy storage device 200 is communicatively connected with a same mobile terminal 400, and the energy storage device 200 may be configured to establish a communication connection with the control module 3112 through the mobile terminal 400. The control module 3112 is configured to control a power supply condition between the energy storage device 200 and the household grid, and transmit the power supply condition to the mobile terminal 400 through communication to display the power supply condition on the mobile terminal 400.

Specifically, for example, the control module 3112 may be bound and communicatively connected with an application on the mobile terminal 400 related to household electricity. When the energy storage device 200 supports a wireless communication function, the energy storage device 200 may also be bound with the control module 3112 through the application on the mobile terminal 400 related to household electricity. When the bound energy storage device 200 is in a powered-on state, the bound energy storage device 200 can be in communication with the control module 3112 through the wireless communication function.

The control module 3112 may be configured to, subsequent to the control module 3112, the energy storage device 200, and the mobile terminal 400 establishing a communication relationship with one another and in response to detecting that the utility power loses power, control the energy storage device 200 to enable the alternating-current output function for outputting the alternating current. In addition, the control module 3112 may also be configured to: transmit, through communication to the application on the mobile terminal 400 related to household electricity, the power supply condition of the energy storage device 200 enabling the alternating-current output function for outputting the alternating current for the household grid, and display the power supply condition on the application on the mobile terminal 400. The power supply condition may include information such as an electrical connection condition between the energy storage device 200 and the household grid, and a power supply duration.

For example, the application on the mobile terminal 400 may be configured to display the electrical connection condition between the energy storage device 200 and the household grid. When the electrical connection between the energy storage device 200 and the household grid is normal, and the energy storage device 200 can normally supply power to the household grid, a state of normal connection between the energy storage device 200 and the household grid is displayed on the application. When the electrical connection between the energy storage device 200 and the household grid is broken, and the energy storage device 200 stops supplying power to the household grid, a state of broken connection between the energy storage device 200 and the household grid is displayed on the application.

In this way, it is convenient for the user to know in real time the power supply condition of the energy storage device 200 to the household grid through the mobile terminal 400.

In some embodiments, the control module 3112 is further configured to receive a user control instruction transmitted by the mobile terminal 400, and control a connection condition between the energy storage device 200 and the household grid based on the user control instruction.

Specifically, the user control instruction may include, for example, an on/off control instruction for the energy storage device 200, a control instruction for adjusting output supply power of the energy storage device 200, an on/off control instruction for the control module 3112, or other control instructions, which are not limited herein.

It should be understood that, since the communication relationship among the control module 3112, the energy storage device 200, and the mobile terminal 400 is established, not only can the control module 3112 and the energy storage device 200 transmit information to the mobile terminal 400 and display the information on the application on the mobile terminal 400, but similarly, the user can also implement operations such as remote on/off control of the energy storage device 200 on the application on the mobile terminal 400 related to household electricity, and operations such as remote control of the control module 3112, which are more convenient, faster, and more intelligent.

In this way, in the present disclosure, the energy storage device 200 having the wireless communication function and the control module 3112 are bound through the same mobile terminal 400 to establish a local area network, which enables the user to remotely control, through a network, the energy storage device 200 and the control module 3112 on the mobile terminal 400, facilitating use and management by the user, and making the control more intelligent.

In some embodiments, the control module 3112 is configured to, in response to the energy storage device 200 being in the powered-on state, read energy storage information of the energy storage device 200 and display the energy storage information on the mobile terminal 400.

Specifically, the energy storage information includes information such as a model, the supply power, and a remaining capacity of the energy storage device 200.

In this way, in the present disclosure, by binding the energy storage device 200 having the wireless communication function with the control module 3112 through the same mobile terminal 400 to establish the local area network, the control module 3112 can automatically read the energy storage information of the energy storage device 200, transmit the energy storage information to the mobile terminal 400, and display the energy storage information on the mobile terminal 400, which is convenient for the user to view the energy storage information of the energy storage device 200 in real time through the mobile terminal 400.

As illustrated in FIG. 4 and FIG. 5, in some embodiments, the control module 3112 includes a first communication unit 31126. The energy storage device 200 includes a second communication unit 210. Each of the first communication unit 31126 and the second communication unit 210 is communicatively connected to the mobile terminal 400. The second communication unit 210 may be configured to establish a communication connection with the first communication unit 31126 through the mobile terminal 400.

That is, the control module 3112 of the present disclosure may have a wired communication function or a wireless communication function, and is provided with the first communication unit 31126. The first communication unit 31126 may include an Internet of Things card or the like. The energy storage device 200 connected to the household power distribution device 100 may also have a wired communication function or the wireless communication function, and is provided with the second communication unit 210. The second communication unit 210 may also include an Internet of Things card or the like. The first communication unit 31126 and the second communication unit 210 may be bound to each other through the mobile terminal 400 to establish a wireless communication relationship. In this way, remote intelligent control over a connection and a disconnection between the energy storage device 200 and the household grid is achieved by the control module 3112 through the mobile terminal 400, realizing higher intelligence.

In addition, it should be understood that, when the user selects the energy storage device 200 that does not have the wireless communication function, the energy storage device 200 cannot be bound to the control module 3112, and thus a connection operation and a disconnection operation of the energy storage device 200 may be manually operated by the user, in such a manner that the energy storage device 200 that does not have the wireless communication function may also have a household emergency backup power function.

In some embodiments, the control module 3112 is further configured to, in a process in which the energy storage device 200 supplies power to the household grid and in response to detecting that the utility power is restored, issue a prompt indicating that the utility power is restored.

Specifically, when the utility power is restored in the process in which the energy storage device 200 supplies power to the household grid, the control module 3112 may, in response to detecting a message indicating that the utility power is restored, prompt the user about the message indicating that the utility power is restored through a notification method predetermined by the user. For example, the user may be specifically prompted about that the utility power is restored by means of an audible and visual alert, or by means of pushing an application message to the mobile terminal 400 that is in wireless communication with the control module 3112.

When the user receives the prompt issued by the control module 3112 and indicating that the utility power is restored, the user may manually disable the alternating-current output function of the energy storage device 200, and then manually close the main line switch 3111 to restore the power supply of the utility power.

When the control module 3112 and the energy storage device 200 are bound to the same mobile terminal 400 to establish the local area network, the user may also remotely disable the alternating-current output function of the energy storage device 200 through the application on the mobile terminal 400 in response to receiving the prompt indicating that the utility power is restored, and set the control module 3112 to close the main line switch 3111 through the mobile terminal 400 or manually close the main line switch 3111 to restore the power supply of the utility power.

In an example, when the prompt issued by the control module 3112 is a voice prompt, the voice prompt may be “The utility power is restored. Please timely disable the alternating-current output function of the energy storage device 200 and close the main line switch!”.

It should be understood that, if the alternating-current output function of the energy storage device 200 is not disabled to release an electrical connection relationship between the energy storage device 200 and the household grid, the main line switch 3111 cannot be unlocked and closed. Therefore, in the present disclosure, in the process in which the energy storage device 200 supplies power to the household grid and in response to detecting that the utility power is restored, the control module 3112 issues the prompt indicating that the utility power is restored, which can prompt the user to timely disable the alternating-current output function of the energy storage device 200 to unlock and close the main line switch 3111, ensuring that a circuit inside the household power distribution device 100 is normal.

In this way, with the household power distribution device 100 of the present disclosure, in the process in which the energy storage device 200 supplies power to the household grid, in response to detecting that the utility power is restored, the prompt indicating that the utility power is restored may be issued through the control module 3112, which facilitates timely disabling the alternating-current output function of the energy storage device 200 by the user to unlock and close the main line switch 3111, ensuring that the circuit inside the household power distribution device 100 is normal.

In some embodiments, the control module 3112 is further configured to adjust a voltage range receivable by the household grid terminal 20, to enable an output voltage of the energy storage device 200 to match an input voltage of the household grid terminal 20.

It should be understood that, since a required range of household alternating current varies in different countries, correspondingly, when the energy storage device 200 is used for emergency power supply, the output voltage corresponding to the energy storage device 200 is also different. Therefore, the output voltage of the energy storage device 200 needs to match a voltage applied by the household, in such a manner that the energy storage device 200 can be normally operated to supply power to the household grid.

As illustrated in FIG. 2, in some embodiments, the power distribution management module 30 of the household power distribution device 100 further includes a plurality of output branch lines 32 electrically connected to the main output line 31. Each of the plurality of output branch lines 32 includes an electrical energy input terminal 321, a household load access terminal 322, and a branch line switch 323. The electrical energy input terminal 321 is connected to the main line switch 3111. The branch line switch 323 is disposed between the electrical energy input terminal 321 and the household load access terminal 322, and is configured to control a connection or a disconnection of a path between the electrical energy input terminal 321 and the household load access terminal 322. The branch line switch 323 may be a circuit breaker.

Specifically, as illustrated in FIG. 2, a corresponding output branch line 32 is provided in each of the bathroom, room 1, room 2, living room, and kitchen in the user's household. That is, each household region is correspondingly provided with the household load access terminal 322 in the power distribution management module 30 of the household power distribution device 100, which is configured for electrical connections with household loads in different household regions. Power consumption of the household load in each household region may be controlled through closing and opening of the branch line switch 323.

For example, when the branch line switch 323 corresponding to the bathroom is closed, a connection of a path between the electrical energy input terminal 321 where the bathroom is located and the household load access terminal 322 is enabled, in which case household loads in the bathroom, such as an electric light and a heater, may be connected to the alternating current for a normal operation. When the branch line switch 323 corresponding to the bathroom is opened, a disconnection of the path between the electrical energy input terminal 321 where the bathroom is located and the household load access terminal 322 is enabled, in which case the household loads in the bathroom, such as the electric light and the heater, cannot be connected to the alternating current and thus stop operating.

In addition, when the energy storage device 200 is connected to the household grid terminal 20 through a socket in the household region to supply power to the household grid, the supply power of the energy storage device 200 is determined by maximum power of the energy storage device 200 used, an overcurrent capability of the socket connected to the energy storage device 200, and an overcurrent capability of the branch line switch 323 on a branch line where the socket is located.

In this way, in the household power distribution device 100 of the present disclosure, the power distribution management module 30 can achieve power consumption control of loads in different household regions through providing the plurality of output branch lines 32.

In some embodiments, the control module 3112 is further configured to adjust the voltage range receivable by the household grid terminal 20, to enable the output voltage of the energy storage device 200 to match the input voltage of the household grid terminal 20.

It should be understood that, since the required range of household alternating current varies in different countries, correspondingly, when the energy storage device 200 is used for emergency power supply, the output voltage corresponding to the energy storage device 200 is also different. Therefore, the output voltage of the energy storage device 200 needs to match the voltage applied by the household, in such a manner that the energy storage device 200 can be normally operated to supply power to the household grid.

With the household power distribution device 100 of the present disclosure, the voltage range receivable by the household grid terminal 20 can be adjusted through the control module 3112, which can enable a compatible access of the energy storage device 200 to different power grids worldwide, and achieve a compatible application that all energy storage devices 200 with alternating current power supply can provide emergency power supply for households, which is conducive to promotion and applications of the energy storage device 200, and expands application scenarios and usage ranges of the energy storage device 200.

In some embodiments, the household power supply network 1000 further includes a smart control socket 300. The smart control socket 300 is disposed between the utility power and a household load and connected to the energy storage device 200. A transfer switch 310 is provided in the smart control socket 300. The transfer switch 310 is capable of selectively connecting the household load to the utility power or selectively connecting the household load to the energy storage device 200. The household load is connected to only one of the utility power or the energy storage device 200 at any time point. The transfer switch 310 is configured to, in response to the utility power being normal, connect a circuit between the utility power and the household load, and disconnect a circuit between the energy storage device 200 and the household load, and is configured to, in response to the utility power losing power, disconnect the circuit between the utility power and the household load, and connect the circuit between the energy storage device 200 and the household load.

Specifically, since the transfer switch 310 is provided in the smart control socket 300 of the present disclosure, circuit connection paths between the household load and each of the utility power and the energy storage device 200 can be flexibly switched through the transfer switch 310, which can avoid a risk of electric shock and the risk of grid connection caused when both the utility power and the energy storage device 200 are connected to the household grid.

In this way, the smart control socket 300 of the present disclosure may be connected to each of the utility power, the energy storage device 200, and the household load, and the transfer switch 310 is provided in the smart control socket 300 to realize on-load switching between the utility power and the energy storage device 200, which can avoid the risk of electric shock and the risk of grid connection caused when both the utility power and the energy storage device 200 are connected to the household grid.

The smart control socket 300 of the present disclosure may be provided with the transfer switch 310, which may be a manual control switch or a smart control switch, and is not limited herein.

In an embodiment, the transfer switch 310 is the manual control switch, and the smart control socket 300 is provided with a control button electrically connected to the transfer switch 310.

Specifically, the control button may be configured to, in response to the control button being in a first state, control the transfer switch 310 to be connected to a utility power side, thereby connecting the circuit between the utility power and the household load.

The control button may be configured to, in response to the control button being in a second state, control the transfer switch 310 to be connected to an energy storage side, connecting the circuit between the energy storage device 200 and the household load.

In this way, in the present disclosure, a connection direction of the transfer switch 310 may be manually controlled through a control button, which can avoid the risk of electric shock and the risk of grid connection caused when both the utility power and the energy storage device 200 are connected to the household grid.

In another embodiment, the transfer switch 310 is the smart control switch, and the smart control socket 300 is provided with a switching control unit electrically connected to the transfer switch 310. The switching control unit is configured to detect whether an electrical signal is present on the energy storage side and the utility power side of the transfer switch, and to control a conduction path of the transfer switch based on a detection result.

Specifically, the electrical signal may be a voltage signal or a current signal, which is not limited herein.

For example, when the switching control unit detects that the utility power side of the transfer switch 310 has a voltage and the energy storage side of the transfer switch 310 has no voltage, it indicates that the utility power is normal. In this case, the transfer switch 310 may be automatically controlled by the switching control unit to be connected to the utility power side, to connect the circuit between the utility power and the household load, in such a manner that the utility power provides electrical energy to the household load. When the switching control unit detects that the utility power side of the transfer switch 310 has no voltage and the energy storage side of the transfer switch 310 has a voltage, it indicates that the utility power loses power. In this case, the transfer switch 310 may be automatically controlled by the switching control unit to be connected to the energy storage side, to connect the circuit between the energy storage device 200 and the household load, in such a manner that the energy storage device 200 provides electrical energy to the household load.

In this way, in the present disclosure, the connection direction of the transfer switch 310 can be intelligently controlled through the switching control unit without manual operation, which can more intelligently avoid the risk of electric shock and the risk of grid connection caused when both the utility power and the energy storage device 200 are connected to the household grid.

It should be understood that, in the related art, in the household power supply network, the household grid is configured with a household power distribution box. The household power distribution box has an end connected to the utility power and another end connected to the household grid. The household power distribution box is composed of a main circuit breaker and a plurality of sub-circuit breakers. Each of at least one of the plurality of sub-circuit breakers is connected to an ordinary socket at a rear end of the sub-circuit breaker. The household load is configured to obtain power through the ordinary socket. When the utility power loses power, the entire household grid completely loses power, and is therefore unable to continue to provide electrical energy to the household load.

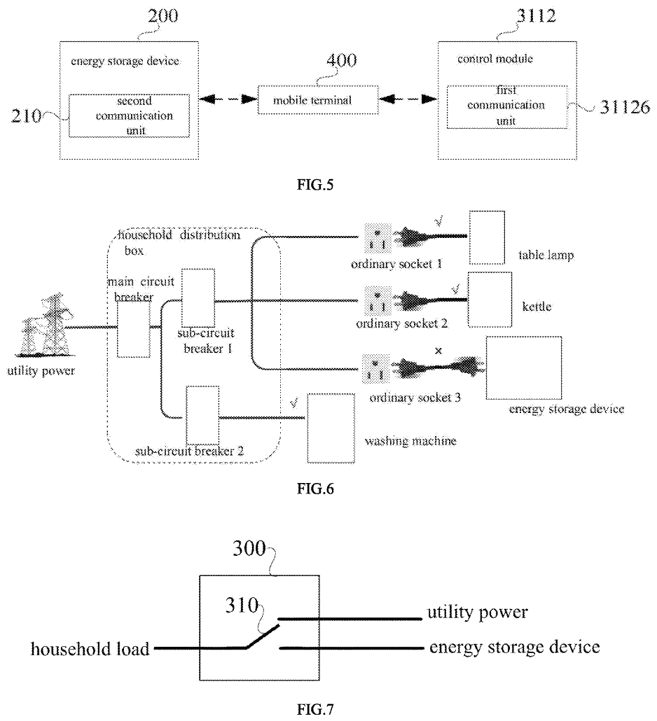

In addition, conventional portable energy storage devices only have an off-grid output function. As a result, if the portable energy storage device is used for household electricity or emergency electricity, when the portable energy storage device is directly connected to the household grid, simultaneous outputs from the utility power and the portable energy storage device would damage household appliances due to a phase difference between their alternating currents. That is, directly connecting the portable energy storage device to the household grid poses the risk of electric shock and the risk of grid connection. As illustrated in FIG. 6, the portable energy storage device is unable to directly supply power to the entire household grid or a local grid through being connected to the ordinary socket.

As illustrated in FIG. 2 and FIG. 7, in some embodiments, the smart control socket 300 is electrically connected to the household power distribution device 100. The power distribution management module 30 includes a plurality of output branch lines 32 electrically connected to the main output line 31. At least one of the plurality of output branch lines 32 is connected to the smart control socket 300.

Specifically, in the present disclosure, the smart circuit breaker 311 is disposed in the household power distribution device 100. The smart circuit breaker 311 includes the main line switch 3111 and the control module 3112. The control module 3112 may be configured to: in response to the utility power being normal and the household grid being disconnected from the energy storage device 200, control the main line switch 3111 to be closed and the transfer switch 310 to connect the circuit between the utility power and the household load, to enable the utility power to supply power to the household grid; and in response to the utility power losing power, control the main line switch 3111 to be opened and the transfer switch 310 to connect the circuit between the energy storage device 200 and the household load, achieving intelligent automatic closing and switching of the main line switch 3111, and realizing intelligent control on the connection direction of the transfer switch 310.

In this case, the smart control socket 300 of the present disclosure can provide automatic switching to supply electrical energy to the household load from the utility power or the energy storage device 200. When the utility power is present, the control module 3112 may control the transfer switch 310 in the smart control socket 300 to switch to the utility power side to supply power to the household load. When the utility power loses power and power is supplied by the energy storage device, the control module 3112 may control the transfer switch 310 in the smart control socket 300 to switch to the energy storage side to supply power to the household load.

In addition, in a case where the main line switch 3111 is closed when the utility power loses power and the energy storage device 200 is connected to the household grid, both the energy storage device 200 and the utility power input the alternating current to the household grid when the utility power is suddenly connected to the household grid, and thus a phase difference between the energy storage device 200 and the utility power may damage devices such as the household load. Therefore, when the energy storage device 200 supplies power to the household load, if the utility power loses power and is then restored, the control module 3112 may control the transfer switch 310 in the smart control socket 300 to switch to the utility power side to supply power to the household load, and re-control the main line switch 3111 to be closed, which can avoid the risk of grid connection caused by the alternating currents output by the utility power and the energy storage device 200 when the utility power is suddenly connected to the household grid, which would lead to damage to devices such as the household load or grid instability.

As illustrated in FIG. 2 and FIG. 8 to FIG. 10, in some embodiments, an output branch line 32 is provided with a branch line switch 323. The smart control socket 300 is connected in series between the main line switch 3111 of the household power distribution device 100 and the branch line switch 323 of the household power distribution device 100; or the smart control socket 300 is connected in series between the branch line switch 323 of the household power distribution device 100 and a predetermined number of ordinary sockets in the household power distribution device 100.

That is, a connection position of the smart control socket 300 can vary with different power supply requirements, and the smart control socket 300 may be selectively connected at different positions based on a demand of the user for emergency power supply to different numbers of household loads.

Specifically, in an embodiment, as illustrated in FIG. 8, the smart control socket 300 is connected in series between the main line switch 3111 and the branch line switch 323. When all the household loads correspondingly connected to the household power distribution device 100 of the user have an emergency backup power demand and a total current flowing through all the household loads is less than or equal to a rated current flowing through the smart control socket 300, the user can connect the smart control socket 300 in series between the main line switch 3111 and the branch line switch 323 to provide emergency backup power to all the household loads.

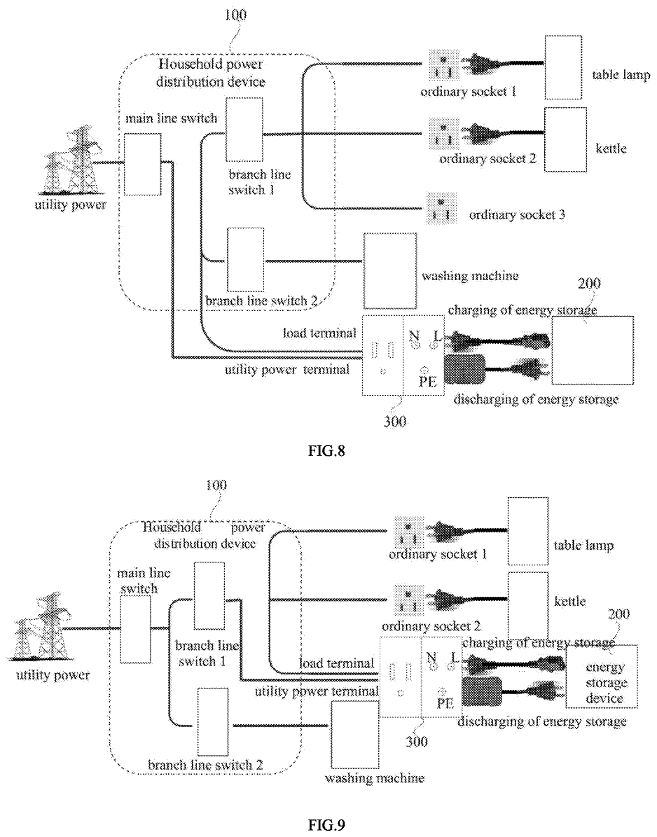

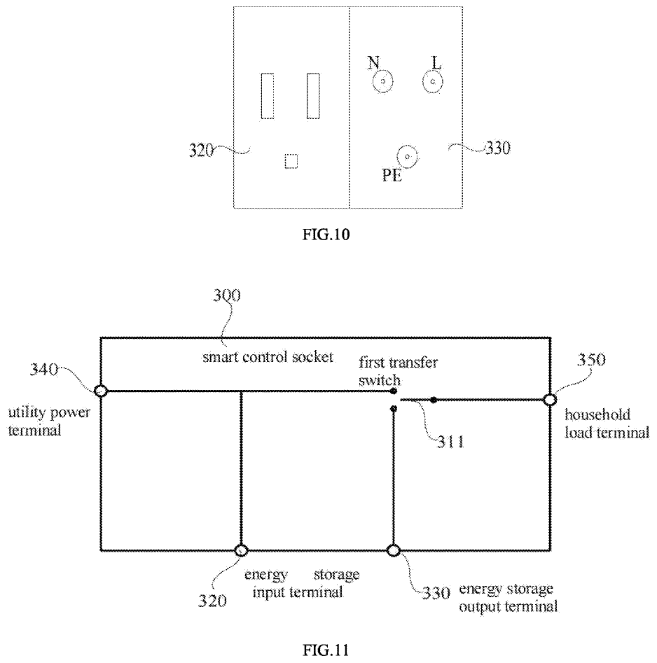

In another embodiment, as illustrated in FIG. 9, the smart control socket 300 is connected in series between the branch line switch 323 and the predetermined number of ordinary sockets. When only some of the household loads correspondingly connected to the household power distribution device 100 of the user have the emergency backup power demand, and some of the household loads are correspondingly connected to a partial portion of a plurality of ordinary sockets in the household power distribution device 100, the user can connect the smart control socket 300 in series between the branch line switch 323 and some of the plurality of ordinary sockets to provide emergency backup power to the some of the household loads.

The predetermined number of ordinary sockets may be a plurality of ordinary sockets having the emergency backup power demand in a partial region. For example, when a number of the plurality of ordinary sockets having the emergency backup power demand in a partial region is 3, the predetermined number is 3. When the number of the plurality of ordinary sockets having the emergency backup power demand in a partial region is 4, the predetermined number is 4. When the number of the plurality of ordinary sockets having the emergency backup power demand in a partial region is 5, the predetermined number is 5.

In addition, when the energy storage device 200 is quickly connected to the household grid terminal 320 through the smart control socket 100 in the household region to supply power to the household load in the household grid, the power supply power of the energy storage device 200 is determined by the maximum power of the energy storage device 200 used, an overcurrent capability of the smart control socket 100 connected to the energy storage device 200, and an overcurrent capability of the branch line switch 323 on a branch line where the smart control socket 100 is located.

In some embodiments, the transfer switch 310 is a relay.

Specifically, a relay is an electrical switching device that uses a small current to control a large current, a core function of which is to isolate a control circuit from a controlled circuit, and to realize signal conversion, amplification, or multi-channel automatic control. The relay is mainly composed of two parts: a control terminal (coil side) and a controlled terminal (contact side). The control terminal (coil side) is an electromagnet system, which may include a coil and an iron core. The controlled terminal (contact side) is a mechanical switch system, which may include a movable contact, a stationary contact, and a spring.

As illustrated in FIG. 10. In some embodiments, the smart control socket 300 includes an energy storage input terminal 320 and an energy storage output terminal 330. The energy storage input terminal 320 is configured to be connected to the energy storage device 200 to charge the energy storage device 200. The energy storage output terminal 330 is configured to be connected to the energy storage device 200 to discharge the energy storage device 200.

That is, in this case, the smart control socket 300 of the present disclosure may be divided into two mutually independent energy storage plug-in interfaces. That is, the energy storage input terminal 320 is a charging plug-in interface. The charging plug-in interface may be a three-pin receptacle as illustrated in FIG. 10. The energy storage output terminal 330 is a discharging plug-in interface. The discharging plug-in interface may be another type of three-pin receptacle as illustrated in FIG. 10. The energy storage input terminal 320 and the energy storage output terminal 330 are independent of each other and do not interfere with each other.

In this way, with the provision of the energy storage input terminal 320 and the energy storage output terminal 330, the smart control socket 300 of the present disclosure can distinguish different interfaces for charging and discharging of the energy storage device 200, which is conducive to improving user experience.

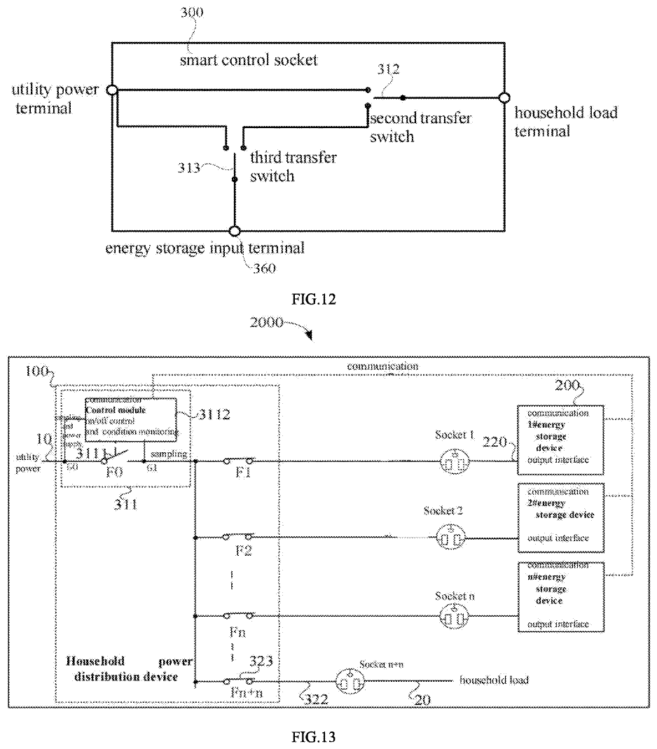

As illustrated in FIG. 11, in some embodiments, the smart control socket 300 further includes a utility power terminal 340, a household load terminal 350, and a first transfer switch 311. The utility power terminal 340 is connected to the energy storage input terminal 320. The household load terminal 350 is selectively connectable to the utility power terminal 340 or the energy storage output terminal 330 through the first transfer switch 311. When the utility power is normal, the household load terminal 350 is connected to the utility power terminal 340 through the first transfer switch 311, utility power inputted from the utility power terminal 340 is supplied to the household load terminal 350, and the utility power terminal 340 charges the energy storage device 200. When the utility power loses power, the household load terminal 350 is connected to the energy storage output terminal 330 through the first transfer switch 311, and the energy storage output terminal 330 supplies power to the household load terminal 350.

Specifically, the first transfer switch 311 may ensure physical mutual exclusion between the utility power terminal 340 and the energy storage output terminal 330, avoiding connections of both the utility power terminal 340 and the energy storage output terminal 330, and preventing reverse power transmission.

The first transfer switch 311 may be a single-pole double-throw switch. As illustrated in FIG. 11, the first transfer switch 311 has a first end connected to the household load terminal 350, and a second end selectively connected to the utility power terminal 340 or the energy storage output terminal 330.

That is, when the utility power is normal, the second end of the first transfer switch 311 may be controlled to be selectively connected to the utility power terminal 340. That is, the utility power terminal 340 and the household load terminal 350 are connected by the first transfer switch 311, which can realize that the utility power supplies power to the household load terminal 350. In addition, in this case, since the utility power terminal 340 is connected to the energy storage input terminal 320, charging of the energy storage device 200 by the utility power can also be realized.

When the utility power loses power, the second end of the first transfer switch 311 may be controlled to be selectively connected to the energy storage output terminal 330. That is, the energy storage output terminal 330 and the household load terminal 350 are connected by the first transfer switch 311, in such a manner that the energy storage device 200 may discharge through the energy storage output terminal 330, supplying power to the household load terminal 350 through the energy storage output terminal 330.

In this way, by separately providing the energy storage input terminal 320 and the energy storage output terminal 330, the smart control socket 300 of the present disclosure can realize a charging process and a discharging process of the energy storage device 200.

In some embodiments, the energy storage device 200 includes a charging cable and a discharging cable. The charging cable is connected to the energy storage input terminal 320 for charging. The discharging cable is connected to the energy storage output terminal 330 for discharging.

That is, the energy storage device 200 of the present disclosure is correspondingly provided with the charging cable and the discharging cable to connect to the energy storage input terminal 320 and the energy storage output terminal 330 of the smart control socket 300, respectively, to realize the charging process and the discharging process of the energy storage device 200. When the energy storage device 200 is in the discharging process, the energy storage device 200 may provide emergency power supply for the household load when the utility power loses power.

As illustrated in FIG. 12, in some embodiments, the smart control socket 300 includes an energy storage input-output terminal 360 connected to the energy storage device 200 to charge or discharge the energy storage device 200.

That is, the smart control socket 300 of the present disclosure may also be provided with only one energy storage input-output terminal 360 as the energy storage plug-in interface. The energy storage device 200 is plugged into the energy storage plug-in interface to realize the charging process or the discharging process of the energy storage device 200.

As illustrated in FIG. 12, in some embodiments, the smart control socket 300 further includes a utility power terminal 340, a household load terminal 350, a second transfer switch 312, and a third transfer switch 313. The household load terminal 350 is selectively connectable to the utility power terminal 340 or the energy storage input-output terminal 360 through the second transfer switch 312. The energy storage input-output terminal 360 is selectively connectable to the utility power terminal 340 or the household load terminal 350 through the third transfer switch 313. When the utility power is normal, the household load terminal 350 is connected to the utility power terminal 340 through the second transfer switch 312, the energy storage input-output terminal 360 is connected to the utility power terminal 340 through the third transfer switch 313, and both the household load terminal 350 and the energy storage input-output terminal 360 are charged by the utility power terminal 340. When the utility power loses power, the energy storage input-output terminal 360 is connected to the household load terminal 350 through the third transfer switch 313 and the second transfer switch 312, and the household load terminal 350 is supplied with power by the energy storage input-output terminal 360.

Specifically, each of the second transfer switch 312 and the third transfer switch 313 may be a single-pole double-throw switch. As illustrated in FIG. 12, the second transfer switch 312 has a first end connected to the household load terminal 350, and a second end selectively connected to the utility power terminal 340 and the third transfer switch 313. The third transfer switch 313 has a first end connected to the energy storage input-output terminal 360, and a second end selectively connected to the utility power terminal 340 and the second transfer switch 312.

When the utility power is normal, the second end of the third transfer switch 313 may be controlled to be selectively connected to the utility power terminal 340, to enable the energy storage input-output terminal 360 to be connected to the utility power terminal 340 via the third transfer switch 313. The second end of the second transfer switch 312 is selectively connected to the utility power terminal 340, to enable the household load terminal 350 to be connected to the utility power terminal 340 via the second transfer switch 312. In this way, a process in which both the household load and the energy storage device 200 can be charged by the utility power can be realized.

When the utility power loses power, the second end of the third transfer switch 313 may be controlled to be selectively connected to the second transfer switch 312, and the second end of the second transfer switch 312 may also be controlled to be selectively connected to the third transfer switch 313. In this case, the energy storage input-output terminal 360 is connected to the household load terminal 350 through the third transfer switch 313 and the second transfer switch 312, realizing a process in which the household load terminal 350 is supplied with power through the energy storage input-output terminal 360.

That is, the smart control socket 300 of the present disclosure may be provided that the energy storage input terminal and the energy storage output terminal share one interface. That is, only one energy storage input-output terminal 360 is provided, in such a manner that the energy storage device 200 can undergo the charging process or the discharging process independently through the energy storage input-output terminal 360.

As illustrated in FIG. 7, in some embodiments, the transfer switch 310 is a single-pole double-throw switch.

Specifically, a group of movable contacts in the single-pole double-throw switch may switch between two stationary contacts, to enable the transfer switch 310 to connect the circuit between the utility power and the household load or the circuit between the energy storage device 200 and the household load.

In some embodiments, a baffle or a protective shutter may be provided in a receptacle of the smart control socket 300 of the present disclosure. Only when two metallic plates of a plug are evenly inserted into the receptacles can the baffles be pushed open and power be supplied. That is, the smart control socket 300 is configured as a terminal-touch-proof smart control socket 300 to prevent the user (especially a child) from directly contacting a live receptacle with a finger or a metallic object, avoiding the risk of electric shock.

For example, as illustrated in FIG. 10, for the smart control socket configured as a three-hole plug having two parts, the baffle is provided in each of an L (live) receptacle and an N (neutral) receptacle of the smart control socket 300. The two baffles are mechanically linked (e.g., by a spring or a lever structure). Only when the two metallic plates of the plug are synchronously and evenly inserted into the receptacles can the baffles be pushed open and power be supplied. An independent baffle is provided inside a PE receptacle of the smart control socket 300. That is, a baffle of a ground receptacle is controlled separately, and the L/N receptacles are allowed to be powered only subsequent to an insertion of a ground pin of the plug. In this way, the user (especially a child) can be prevented from directly contacting the live receptacle with the finger or the metallic object, avoiding the risk of electric shock.

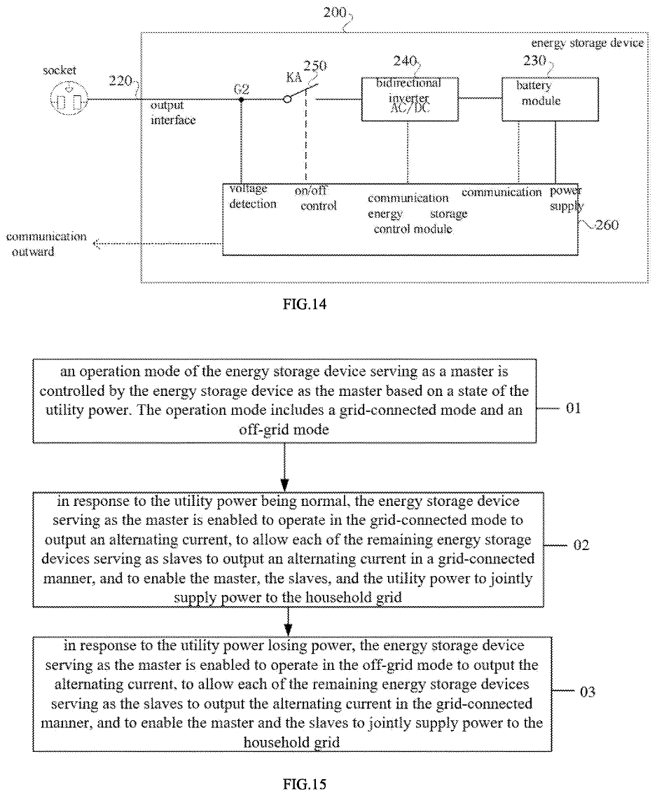

As illustrated in FIG. 13 and FIG. 14, the household power supply network 1000 of the present disclosure includes a plurality of energy storage devices 200. The present disclosure further provides a distributed energy storage system 2000. The plurality of energy storage devices 200 jointly form the distributed energy storage system 2000. Each of the plurality of energy storage devices 200 includes an output interface 220. The energy storage device 200 and remaining energy storage devices 200 of the plurality of energy storage devices 200 are connected in parallel to the household grid through the output interfaces 220. The energy storage device 200 and the remaining energy storage devices 200 are connected in one-to-one correspondence to a plurality of smart control sockets 300 through the output interfaces 220. The energy storage device 200 is communicatively connected to the remaining energy storage devices 200. The energy storage device 200 serving as a master is configured to control an operation mode of the energy storage device 200 based on a state of the utility power. The operation mode includes a grid-connected mode and an off-grid mode. When the utility power is normal, the energy storage device 200 serving as the master operates in the grid-connected mode to output an alternating current, to enable each of the remaining energy storage devices 200 serving as slaves to output an alternating current in a grid-connected manner, and to enable the master, the slaves, and the utility power to jointly supply power to the household grid. When the utility power loses power, the energy storage device 200 serving as the master operates in the off-grid mode to output the alternating current, to enable each of the remaining energy storage devices 200 serving as the slaves to output the alternating current in the grid-connected manner. Thus, the master and the slaves jointly supply power to the household grid.

Therefore, among the plurality of energy storage devices 200 of the present disclosure, only communication connections are required, without a need to mount any cable. By inserting the plurality of energy storage devices 200 into any household sockets as desired, the distributed energy storage system 2000 including the plurality of energy storage devices 200 for energy management can be formed.

For example, as illustrated in FIG. 13, the distributed energy storage system includes n energy storage devices 200. That is, energy storage devices 1 190 and 2 #to n #are inserted through the output interfaces 220 into smart control sockets 1 to n on a wall, respectively, and supply power to another smart control socket n+n through the household grid. The household load is connected to the smart control socket n+n. Energy storage device 1 #may be determined as the master, while energy storage devices 2 #to n #may be determined as the slaves. Thus, the energy storage device 1 #can control an operation status of energy storage devices 2 #to n #. In other embodiments, other master-slave settings can also be adopted, which are not limited herein.

In addition, when the master outputs the alternating current in the grid-connected manner and controls the slave to output the alternating current in the grid-connected manner, bidirectional inverters in both the master and the slave operate in a current source mode. When the master outputs the alternating current in the off-grid manner and controls the slave to output the alternating current in the grid-connected manner, the bidirectional inverter in the master operates in a voltage source mode, and the bidirectional inverter in the slave operates in the current source mode.

In this way, the plurality of energy storage devices 200 of the present disclosure are communicatively connected to each other without a need to mount any cable. The energy storage device 200 serving as the master is capable of controlling the operation mode of the energy storage device 200 to be the grid-connected mode or the off-grid mode based on the state of the utility power. The operation mode of the energy storage device 200 serving as the master can affect electrical energy outputs of the remaining energy storage devices serving as the slaves, simply realizing a high-power current output function of the household energy storage device 200, meeting demands of the entire household grid, and being less likely to cause safety hazards.

In some embodiments, the plurality of energy storage devices 200 are configured to automatically assign logical addresses through a communication protocol to determine the master and the slaves based on the logical addresses.

Specifically, for example, as illustrated in FIG. 13, energy storage devices 1 #and 2 #to n #can automatically assign the logical addresses through the communication protocol to compete for the master and the slaves. For example, based on an assign result of the logical addresses, if energy storage device 1 #is determined as the master and energy storage devices 2 #to n #are determined as the slaves, energy storage device 1 #may control the operation status of energy storage devices 2 #to n #.

In some embodiments, the master is capable of obtaining battery levels of the slaves through a communication connection, and the master is configured to control inputs and/or outputs of the slaves based on the battery levels of the slaves.

That is, the master of the present disclosure is capable of obtaining the battery level of the slave in real time through communication, and controlling the input and/or the output of the slave based on the battery level of the slave, which includes the following three situations: (1) the battery level of the slave is obtained, and only the input of the slave is controlled based on the battery level of the slave; (2) the battery level of the slave is obtained, and only the output of the slave is controlled based on the battery level of the slave; (3) the battery level of the slave is obtained, and the outputs and the inputs of the remaining slaves are controlled based on the battery level of the slave. For example, the above situation (3) may include a scenario where the output of one slave is controlled to be disabled, and another slave may be controlled to input electrical energy to said slave.

In this way, with the master of the present disclosure, the battery level of the slave can be obtained through communication, and the input and the output of the slave can be controlled based on the battery level of the slave. Such a control method is simple and easy to implement.

In some embodiments, the master is configured to control output power of the slaves to decrease as the battery levels of the slaves decrease.

For example, if the current total load power of the household grid is 6,000 W, and the master obtains that a battery level value of slave 1 is 80%, the master can control output power of slave 1 to be 2,000 W. If the master obtains that a battery level value of slave 2 is 50%, the master can control output power of slave 2 to be 1,500 W. Consequently, the battery levels of slave 1 and slave 2 tend to be close after a period of time, which is conducive to consistent control of charging and discharging of slave 1 and slave 2, enabling slave 1 and slave 2 to be charged and discharged simultaneously.

In this way, the energy storage device 200 serving as the master in the distributed energy storage system 2000 of the present disclosure can control a magnitude of the output power of the slave in real time through obtaining the battery level of the slave.

In some embodiments, the master is configured to, in response to a determination by the master through the communication connection that a battery level of one of the slaves is less than or equal to a first battery level value, control the one of the slaves to disable an output, and control remaining slaves to increase output power, to compensate for an output deficit of the one of the slaves.

Specifically, the first battery level value may be, for example, 1%, 2%, 3%, 4%, 5%, 6%, 7%, 8%, 9%, or 10%, which is not limited herein.

For example, when the first battery level value is 10%, the master obtains, through communication, that the battery level of slave 3 is 10%. That is, the battery level of slave 3 is equal to the first battery level value in this case. Thus, slave 3 may be controlled to disable the output, and the output deficit of slave 3 is compensated for by other slaves.

In this way, in the distributed energy storage system of the present disclosure, when the battery level of the slave is too low, the master may control the slave to disable the output, to avoid over-discharge of a battery in the slave, prolonging a lifespan of the battery in the slave.

In some embodiments, the master is configured to, in response to a determination by the master through a communication connection that a battery level of a first slave is greater than or equal to a second battery level value and a battery level of a second slave is less than or equal to a third battery level value, control the first slave to charge the second slave through the household grid. The second battery level value is greater than the third battery level value.

Specifically, the second battery level value may be, for example, 80%, 81%, 82%, 85%, 86%, 87%, 88%, 89%, 90%, or 100%, which is not limited herein.

The third battery level value may be, for example, 1%, 2%, 3%, 4%, 5%, 6%, 7%, 9%, 10%, or 15%, which is not limited herein.

For example, the battery level of first slave 4 is 90%, and the battery level of second slave 5 is 10%. In this case, the master may control the first slave 4 to charge the second slave 5 through the household grid.

That is, in the distributed energy storage system of the present disclosure, the master may control the slave having a higher battery level to perform internal self-charging on the slave having a lower battery level through the household grid.

As illustrated in FIG. 14, in some embodiments, the energy storage device 200 further includes a battery module 230, a bidirectional inverter 240, an energy storage switch 250, and an energy storage control module 260. The energy storage control module 260 is communicatively connected to the bidirectional inverter 240 and the energy storage switch 250. The battery module 230 is electrically connected to the bidirectional inverter 240. The energy storage switch 250 is disposed between the bidirectional inverter 240 and the output interface 220. The energy storage control module 260 is configured to, in response to the utility power being normal, control the energy storage switch 250 to be closed, and control the bidirectional inverter 240 to convert a direct current output by the battery module 230 into an alternating current synchronized in phase with the utility power, to enable the energy storage device 200 to be connected to the household grid in the grid-connected manner.

Specifically, the energy storage device 200 may internally include the battery module 230, the bidirectional inverter 240, the energy storage switch 250, and the energy storage control module 260. The battery module 230 is configured to store the battery level. The bidirectional inverter 240 is configured for a current conversion in the charging process and the discharging process. The energy storage switch 250 is configured to control a connection and a disconnection of discharging of the battery module 230 and to control a connection and a disconnection of charging of the battery module 230.

The energy storage control module 260 may be configured to monitor a battery level of the battery module 230 through communication. The energy storage control module 260 may be configured to control a connection and a disconnection of the energy storage switch 250 through communication.

The energy storage control module 260 may be further configured to control a connection and a disconnection of relay KA in the bidirectional inverter 240 through communication, controlling an operation mode of the bidirectional inverter 240. The bidirectional inverter 240 has two operation modes, one of which is an inversion mode (DC→AC), and the other of which is a rectification mode (AC→DC). In the rectification mode, the alternating current is supplied from the utility power and converted into the direct current to charge the battery module. In the inversion mode, a direct current from the battery is converted into the alternating current, which is supplied to the load or fed back to the utility power.

In an embodiment, when the battery module 230 performs discharging, the bidirectional inverter 240 operates in the inversion mode (DC→AC), and the energy storage control module 260 controls relay KA in the bidirectional inverter 240 to be closed, in such a manner that the direct current of the battery module 230 may be converted into the alternating current consistent in phase with the utility power and output to the household grid. As a result, the battery module 230 supplies power to the household grid, realizing that both the energy storage device 200 and the utility power supply power to the household grid. That is, in this case, the energy storage device 200 is connected to the household grid in the grid-connected manner.

In another embodiment, when the utility power connected to the household grid loses power, the energy storage control module 260 may also control relay KA in the bidirectional inverter 240 to be opened to isolate the utility power, and the bidirectional inverter 240 may operate in the inversion mode to supply power to the household load in the household grid.

In yet another embodiment, the energy storage control module 260 is configured to control relay KA in the bidirectional inverter 240 to be closed, and the bidirectional inverter 240 may be switched to the rectification mode (AC→DC), to enable the battery module 230 to be connected to the alternating current output by the utility power to charge the battery module 230, or to enable the battery module 230 to be connected to the alternating current outputted by a photovoltaic inverter to charge the battery module 230.

It should be noted that the energy storage control module 260 may be a separate control module. Three modules, namely, the battery module 230, the bidirectional inverter 240, and the energy storage switch 250 are uniformly controlled by the control module. That is, the energy storage control module 260 may serve as a separate control module and is configured to control the battery module 230, the bidirectional inverter 240, and the energy storage switch 250.

The energy storage control module 260 may also be a control module formed by assembling a plurality of sub-control modules. The plurality of sub-control modules are configured to independently control the battery module 230, the bidirectional inverter 240, and the energy storage switch 250, respectively. In this way, when one sub-control module fails, the remaining sub-control modules can still operate normally without affecting normal control of the corresponding functional modules by the remaining sub-control modules, and only the failed sub-control module needs to be repaired, making maintenance simple. For example, when the sub-control module corresponding to the battery module 230 fails, functional control of the sub-control modules corresponding to the bidirectional inverter 240 and the energy storage switch 250 is not affected, and only the sub-control module corresponding to the battery module 230 needs to be repaired, making maintenance simple.

In this way, in the distributed energy storage system 2000 of the present disclosure, the battery module 230, the bidirectional inverter 240, and the energy storage switch 250 inside the energy storage devices 200 are monitored by the plurality of energy storage devices 200 through the energy storage control module 260, which enables the plurality of energy storage devices 200 to be connected to the household grid in the grid-connected manner, realizing a high-power output function of the distributed energy storage system 2000.

In some embodiments, the energy storage control module 260 is configured to, in response to the utility power being normal and a battery level of the energy storage device 200 being greater than or equal to a first predetermined threshold, control the energy storage switch 250 to be closed, and control the bidirectional inverter 240 to convert the direct current outputted by the battery module 230 into the alternating current synchronized in phase with the utility power, to enable the energy storage device 200 to supply power to the household grid. The energy storage control module 260 is further configured to, in response to the utility power being normal and the battery level of the energy storage device 200 being less than or equal to a second predetermined threshold, control the energy storage switch 250 to be closed, and control the bidirectional inverter 240 to be in a rectification mode, to charge the battery module 230 by the utility power.

Specifically, the first predetermined threshold may be, for example, 90%, 80%, 70%, 60%, or 50%, which is not limited herein. The second predetermined threshold may be, for example, 5%, 10%, 15%, or 20%, which is not limited herein.

That “in response to the utility power being normal and a battery level of the energy storage device 200 being greater than or equal to a first predetermined threshold, control the energy storage switch 250 to be closed, and control the bidirectional inverter 240 to convert the direct current outputted by the battery module 230 into the alternating current synchronized in phase with the utility power, to enable the energy storage device 200 to supply power to the household grid” means that the energy storage device 200 and the utility power may jointly supply power to the household grid when the battery level of the energy storage device 200 is high.

That is, when the battery level of the battery module 230 is higher than the first predetermined threshold, the bidirectional inverter 240 may perform inversion discharge to output power to the household grid for supplying power to the household load, saving household electricity bills.

That “in response to the utility power being normal and the battery level of the energy storage device 200 being less than or equal to a second predetermined threshold, control the energy storage switch 250 to be closed, and control the bidirectional inverter 240 to be in a rectification mode, to charge the battery module 230 by the utility power” means that the battery module may be charged through the utility power when the battery level of the energy storage device 200 is low.

That is, when the battery level of the battery module 230 is lower than the second predetermined threshold, the bidirectional inverter 240 can switch to the rectification mode to charge the battery module 230, to ensure an appropriate battery level of the battery module 230. In this way, the battery module 230 may output electrical energy as the backup power supply to the household grid during the power outage of the utility power.

In some embodiments, the energy storage control module 260 in the master is configured to, in response to detecting that a battery level of the master is lower than a predetermined battery level value, control the master to disable an output of an alternating current. The slaves are configured to, subsequent to the slaves detecting that the master disables the output of the alternating current, reassign logical addresses through a communication protocol to determine one of the slaves as a new master, in such a manner that the energy storage control module 260 in the new master controls the bidirectional inverter 240 in the new master to output an alternating current, to supply power to the household grid.

Specifically, the predetermined battery level value may be 0, 0.01%, 0.02%, 0.03%, 0.04%, 0.05%, 0.06%, 0.07%, 0.08%, or 0.09%, which is not limited herein.

That is, the energy storage control module 260 in the master of the present disclosure is capable of monitoring the battery level of the battery module 230 in the master in real time. When the battery level of the battery module 230 in the master is lower than the predetermined battery level value, the energy storage control module 260 in the master may automatically control the master to disable the output of the alternating current. That is, the energy storage control module 260 is capable of controlling the energy storage switch 250 to be opened, to avoid a problem of over-discharge of the master.

The plurality of slaves are configured to, subsequent to the plurality of slaves detecting that the master disables the output of the alternating current, reassign the logical addresses through the communication protocol to determine the one of the slaves as the new master, in such a manner that the energy storage control module 260 in the new master controls the bidirectional inverter 240 in the new master to output the alternating current, enabling the remaining slaves to still normally supply power to the household grid.

For example, if the battery level of master 1 #in FIG. 13 is 0, master 1 #automatically disables the output of the alternating current. Remaining mobile energy storage units 2 #to n #reassign logical addresses 1 #to (n-1) #. The slave whose logical address is 1 #is determined to be the new master.

In this way, in the distributed energy storage system 2000 of the present disclosure, when the battery level of the master is too low, the remaining slaves can determine the new master on their own to continue supplying power to the household grid, achieving intelligent management of distributed energy.

As illustrated in FIG. 14, in some embodiments, the energy storage control module 260 in the master is configured to, in response to the utility power losing power and detecting that no voltage is present on an output interface side of the energy storage switch 250, determine that the household grid is in an off-grid state, and control the bidirectional inverter 240 in the master to output an alternating current in an off-grid manner to supply power to the household grid. The energy storage control modules 260 in the slaves are configured to, in response to detecting that a voltage is present on the output interface side of the energy storage switch 250, control each of the bidirectional inverters 240 in the slaves to output an alternating current in a grid-connected manner, to enable the slaves to supply power to the household grid.

Specifically, as illustrated in FIG. 14, a voltage sampling point on the output interface side of the energy storage switch 250 of the energy storage control module 260 is point G2. When the energy storage control module 260 in the master detects that no voltage is present at point G2 in the master, it indicates that the utility power is disconnected from the household grid in this case. That is, the utility power is currently in the power-loss state, and the household grid is in the off-grid state. Thus, the bidirectional inverter 240 in the master can be controlled by the energy storage control module 260 to output the alternating current in the off-grid manner to supply power to the household grid, providing emergency power supply to the household grid.

It should be understood that, since a plurality of slaves are connected in parallel to one master, when the energy storage control module 260 in the slave detects that the voltage is present at point G2 in the slave, it may indicate that the master is currently outputting the alternating current to supply power to the household grid. Therefore, when the energy storage control module 260 receives a detection signal indicating that the voltage is present at point G2, the bidirectional inverter 240 in the slave may be controlled to output the alternating current in the grid-connected manner, to enable the remaining slaves to also supply power to the household grid, realizing the high-power output function of the distributed energy storage system 2000.

In this way, in the distributed energy storage system 2000 of the present disclosure, when the utility power loses power, i.e., the household grid is in the off-grid state, the master can also control the slaves to supply power to the household grid together, realizing the high-power output function of the distributed energy storage system 2000.

In some embodiments, the energy storage control module 260 in the master is configured to, in response to the utility power being normal and detecting that a voltage is present on an output interface side of the energy storage switch 250, determine that the household grid is in a grid-connected state, and control the bidirectional inverter 240 in the master to perform an inversion to output an alternating current synchronized in phase with the utility power to supply power to the household grid. The energy storage control modules 260 in the remaining slaves are configured to, in response to detecting that the voltage is present on the output interface side of the energy storage switch 250, control the bidirectional inverters in the slaves to perform an inversion to output an alternating current synchronized in phase with the master, to enable the remaining slaves to supply power to the household grid.

Specifically, as illustrated in FIG. 14, the voltage sampling point on the output interface side of the energy storage switch 250 of the energy storage control module 260 is point G2. When the energy storage control module 260 in the master detects that the voltage is present at point G2 in the master, it indicates that the utility power is connected to the household grid in this case. That is, the utility power is currently in a normal state, and the household grid is in the grid-connected state. Thus, the bidirectional inverter 240 in the master can be controlled by the energy storage control module 260 to output the alternating current in the grid-connected manner to supply power to the household grid, providing emergency power supply to the household grid.

It should be understood that, since the plurality of slaves are connected in parallel to one master, when the energy storage control module 260 in each slave detects that the voltage is present at point G2 in the slave, it may indicate that the master is currently outputting the alternating current to supply power to the household grid. Therefore, when the energy storage control module 260 receives the detection signal indicating that the voltage is present at point G2, the bidirectional inverter 240 in the slave may be controlled to output the alternating current synchronized in phase with the master in the grid-connected manner, to enable the remaining slaves to also supply power to the household grid, realizing the high-power output function of the distributed energy storage system 2000.

In this way, in the distributed energy storage system 2000 of the present disclosure, when the utility power loses power, i.e., the household grid is in the grid-connected state, the master can also control the slaves to supply power to the household grid together with the utility power, realizing the high-power output function of the distributed energy storage system 2000.

As illustrated in FIG. 2 and FIG. 13. In some embodiments, the distributed energy storage system 2000 further includes the household power distribution device 100. Specifically, the household power distribution device 100 may be a distribution box. That is, the household power distribution device 100 of the present disclosure is provided with the smart circuit breaker 311. The smart circuit breaker 311 is capable of controlling, in response to the utility power losing power, the main line switch 3111 to be opened, to enable the energy storage device 200 to supply power to the household grid, which can ensure that the household grid switches from the grid-connected state to the off-grid state to stably provide emergency power supply to the household grid.

Providing the smart circuit breaker 311 in the household power distribution device 100 of the present disclosure can ensure intelligent control of the energy storage device 200 when the household grid switches between the grid-connected state and the off-grid state.

In addition, the household power distribution device 100 of the present disclosure can form communicative coordination with the energy storage device 200 without modifying other cables, which realizes intelligent energy management of the distributed energy storage system 2000 in a mobile manner, and is highly convenient and labor-saving. Further, since the energy storage device 200 is in communicative coordination with the household power distribution device 100, the energy storage device 200 does not need to be placed in close proximity to the household power distribution device 100, facilitating a flexible movement of the energy storage device 200.

In some embodiments, the control module 3112 is configured to, in response to the utility power being restored subsequent to a power outage and in response to detecting that a current is present on each of a first end of the main line switch 3111 connected to the utility power and a second end of the main line switch 3111 connected to the energy storage device 200, notify the energy storage device 200 through communication to stop outputting the alternating current. The control module 3112 is further configured to, in response to the energy storage device 200 stopping outputting the alternating current and in response to detecting that no voltage is present on the second end of the main line switch 3111, control the main line switch 3111 to be closed. The energy storage control module 260 is configured to, subsequent to the main line switch 3111 being closed, control the energy storage switch 250 to be closed, to enable the plurality of energy storage devices 200 to be connected to the household grid in a grid-connected manner.

Specifically, as illustrated in FIG. 13, a voltage sampling point G0 may be provided at the first end of the main line switch 3111 connected to the utility power, and a voltage sampling point G1 may also be provided at the second end of the main line switch 3111 connected to the energy storage device 200. The control module 3112 may be configured to control, based on voltage values collected at point G0 and point G1, the energy storage device 200 to output the alternating current or stop outputting the alternating current and a connection and a disconnection of the main line switch 3111.

When the utility power is restored subsequent to the power outage, the control module 3112 is powered on. Since the energy storage device 200 is currently providing emergency power to the household grid, the control module 3112 may detect that both point G0 and point G1 receive power in this case.

In this case, to prevent a circuit short caused by directly closing the main line switch 3111 and connecting the utility power to the alternating current output in the off-grid manner by the energy storage device 200, that is, when the energy storage system operates in the off-grid mode (i.e., disconnected from the utility power and supplying power independently), an open circuit occurs when an alternating-current output terminal of the energy storage system is accidentally short-circuited with a utility power line, and thus the control module 3112 may communicate with the energy storage devices (1 #to n #) 200 to notify the energy storage devices (1 #to n #) 200 to stop outputting the alternating current.

Subsequent to the energy storage device 200 stopping outputting the alternating current, and when the control module 3112 detects that point G1 has no power, the control module 3112 controls the main line switch 3111 to be closed. Subsequently, the energy storage switch 250 is controlled to be closed, enabling energy storage devices (1 #to n #) 200 to operate in the grid-connected manner to supply power to the household grid.

In this way, when the utility power is restored subsequent to the power outage of the utility power, the distributed energy storage system 2000 of the present disclosure may control, through the control module 3112, the energy storage device 200 to stop outputting the alternating current, the main line switch 3111 to be closed, and then control the energy storage device 200 to operate in the grid-connected manner to supply power to the household grid, which can ensure safety performance of a circuit inside the distributed energy storage system 2000 during switching from the off-grid manner to the grid-connected manner.

In some embodiments, the energy storage device 200 includes a photovoltaic input interface. The energy storage device 200 may be configured to receive photovoltaic energy through the photovoltaic input interface to supply power to the household grid.

That is, the energy storage device 200 of the present disclosure may be charged using the photovoltaic energy. In other embodiments of the present disclosure, the energy storage device 200 may also have other direct-current output functions, which are not limited herein.

As illustrated in FIG. 15, the present disclosure further provides a parallel control method applied in a plurality of energy storage devices. Each of the plurality of energy storage devices includes an output interface. The energy storage device and remaining energy storage devices of the plurality of energy storage devices are connected in parallel to the household grid through the output interfaces. The household grid is connectable to the utility power and/or the energy storage device. The household grid is provided with a socket. The energy storage device and the remaining energy storage devices are connected in one-to-one correspondence to a plurality of sockets through the output interfaces. The energy storage device is communicatively connected to the remaining energy storage devices. The parallel control method includes the following operations.

At 01, an operation mode of the energy storage device serving as a master is controlled by the energy storage device as a master based on a state of the utility power. The operation mode includes a grid-connected mode and an off-grid mode.

At 02, in response to the utility power being normal, the energy storage device serving as the master is enabled to operate in the grid-connected mode to output an alternating current, to allow each of the remaining energy storage devices serving as slaves to output an alternating current in a grid-connected manner, and to enable the master, the slaves, and the utility power to jointly supply power to the household grid.

At 03, in response to the utility power losing power, the energy storage device serving as the master is enabled to operate in the off-grid mode to output the alternating current, to allow each of the remaining energy storage devices serving as the slaves to output the alternating current in the grid-connected manner, and to enable the master and the slaves to jointly supply power to the household grid.

That is, the parallel control method of the present disclosure is a relevant control scheme with the energy storage device serving as the master as a main subject. The operation mode of the energy storage device serving as the master may be controlled by the energy storage device as the master based on the state of the utility power, and can affect the electrical energy outputs of the remaining energy storage devices serving as the slaves. The socket mentioned herein may be the smart control socket 300 described above.

It should be understood that, typically, an energy storage device stores electrical energy through a battery module, and releases the electrical energy stored in the battery module when needed. When power of the alternating current outputted by one energy storage device cannot meet a power demand of the load, the plurality of energy storage devices may be operated in parallel to jointly provide electrical energy to the load to meet the power demand of the load. To ensure that the plurality of energy storage devices can operate in parallel, safely and stably to achieve purposes of improving a power generation efficiency and enhancing system reliability, the master and the slaves usually need to be determined.

In the parallel control method of the present disclosure, the operation mode of the energy storage device serving as the master is controlled by the energy storage device as the master to be the grid-connected mode and the off-grid mode based on the state of the utility power. When the utility power is normal, the energy storage device serving as the master controls its own operation mode to be the grid-connected mode. When the utility power loses power, the energy storage device serving as the master controls its own operation mode to be the off-grid mode.

In detail, when the utility power is normal, the energy storage device serving as the master operates in the grid-connected mode to output the alternating current, to allow each of the remaining energy storage devices serving as the slaves to output the alternating current in the grid-connected manner, and to enable the master, the slaves, and the utility power to jointly supply power to the household grid. In this way, a high-power function for supplying power to the household grid through the energy storage devices can be realized simply.

When the utility power loses power, the energy storage device serving as the master operates in the off-grid mode to output the alternating current, to allow each of the remaining energy storage devices serving as the slaves to output the alternating current in the grid-connected manner, and to enable the master and the slaves to jointly supply power to the household grid. In this way, the high-power function for supplying power to the household grid through the energy storage devices can be realized simply.

In this way, in the parallel control method of the present disclosure, the plurality of energy storage devices are communicatively connected to each other without the need to mount any cable. The energy storage device serving as the master is capable of controlling the operation mode of the energy storage device to be the grid-connected mode or the off-grid mode based on the state of the utility power. The operation mode of the energy storage device serving as the master can affect the electrical energy outputs of the remaining energy storage devices serving as the slaves, simply realizing the high-power current output function of the household energy storage device, meeting the demands of the entire household grid, and being less likely to cause the safety hazards.

In some embodiments, the parallel control method includes the following operation.

At 04, logical addresses are automatically assigned to the energy storage devices based on a communication protocol between the energy storage devices, and a first energy storage device is determined as the master and a second energy storage device is determined as the slave based on the logical addresses.

That is, with the parallel control method of the present disclosure, the logical addresses may be automatically assigned to the energy storage devices based on the communication protocol between the energy storage devices, and the first energy storage device may be determined as the master and the second energy storage device may be determined as the slave based on the logical addresses.

For example, as illustrated in FIG. 13, energy storage devices 1 # and 2 #to n #can automatically assign the logical addresses through the communication protocol to compete for the master and the slaves. For example, based on the assigned result of the logical addresses, if energy storage device 1 #is determined as the master and energy storage devices 2 #to n #are determined as the slaves, energy storage device 1 #may control the operation status of energy storage devices 2 #to n #.

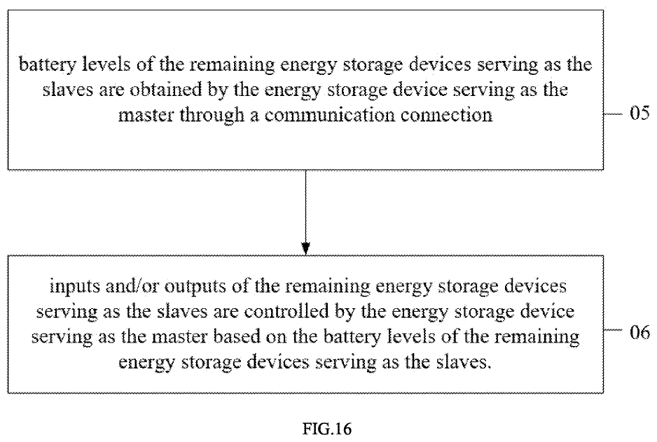

As illustrated in FIG. 16, in some embodiments, the parallel control method includes the following operations.

At block 05, battery levels of the remaining energy storage devices serving as the slaves are obtained by the energy storage device serving as the master through a communication connection.

At block 06, inputs and/or outputs of the remaining energy storage devices serving as the slaves are controlled by the energy storage device serving as the master based on the battery levels of the remaining energy storage devices serving as the slaves.

That is, the energy storage device serving as the master of the present disclosure is capable of obtaining the battery levels of the remaining energy storage devices serving as the slaves in real time through communication, and controlling the inputs and/or the outputs of the remaining energy storage devices serving as the slaves based on the battery levels of the remaining energy storage devices serving as the slaves, which includes the following three situations: (1) the battery levels of the remaining energy storage devices serving as the slaves are obtained, and only the inputs of the remaining energy storage devices serving as the slaves are controlled based on the battery levels of the remaining energy storage devices serving as the slaves; (2) the battery levels of the remaining energy storage devices serving as the slaves are obtained, and only the outputs of the remaining energy storage devices serving as the slaves are controlled based on the battery levels of the remaining energy storage devices serving as the slaves; (3) the battery level of an energy storage device serving as the slave is obtained, and the outputs and the inputs of the remaining energy storage devices serving as the slaves are controlled based on the battery level of the energy storage device serving as the slave. For example, the above situation (3) may include a scenario where the output of one slave is controlled to be disabled, and the remaining slaves are controlled to input electrical energy to the one slave.

In this way, with the energy storage device serving as the master of the present disclosure, the battery levels of the remaining energy storage devices serving as the slaves may be obtained through communication, and the inputs and the outputs of the remaining energy storage devices serving as the slaves may be controlled based on the battery levels of the remaining energy storage devices serving as the slaves. Such a control method is simple and easy to implement.

In some embodiments, the parallel control method includes the following operation.

At 07, output power outputted by the remaining energy storage devices serving as the slaves is controlled by the energy storage device serving as the master to decrease as the battery levels of the remaining energy storage devices serving as the slaves decrease.

For example, if the current total load power of the household grid is 6,000 W, and the energy storage device serving as the master obtains that the battery level value of slave 1 is 80%, the energy storage device serving as the master can control the output power of slave 1 to be 2,000 W. If the energy storage device serving as the master obtains that the battery level value of slave 2 is 50%, the energy storage device serving as the master can control the output power of slave 2 to be 1,500 W. Consequently, the battery levels of slave 1 and slave 2 tend to be close after a period of time, which is conducive to the consistency control of the charging and the discharging of slave 1 and slave 2, enabling slave 1 and slave 2 to be charged and discharged simultaneously.

In this way, in the parallel control method of the present disclosure, the energy storage device serving as the master can control the magnitude of the output power of the energy storage device serving as the slave in real time through obtaining the battery level of the energy storage device serving as the slave.

In some embodiments, the parallel control method includes the following operation.

At 08, in response to a determination, by a first energy storage device serving as the master through a communication connection, that a battery level of a second energy storage device serving as the slave is less than or equal to a first battery level value, the second energy storage device serving as the slave is controlled to disable an output, and the remaining energy storage devices serving as the slaves are controlled to increase output power, to compensate for an output deficit of the second energy storage device.

Specifically, the first battery level value may be, for example, 1%, 2%, 3%, 4%, 5%, 6%, 7%, 8%, 9%, or 10%, which is not limited herein.

For example, when the first battery level value is 10%, the first energy storage device serving as the master obtains, through communication, that the battery level of the second energy storage device serving as slave 3 is 10%. That is, the battery level of the second energy storage device serving as slave 3 is equal to the first battery level value in this case. Thus, the second energy storage device serving as slave 3 may be controlled to disable the output, and the output deficit of slave 3 is compensated for by the remaining slaves.

In this way, in the parallel control method of the present disclosure, when the battery level of the second energy storage device serving as the slave is too low, the first energy storage device serving as the master may control the second energy storage device serving as the slave to disable the output, to avoid over-discharge of a battery in the second energy storage device serving as the slave, prolonging a lifespan of the battery in the slave.

In some embodiments, the parallel control method includes the following operation.

At 09, in response to a determination, by a first energy storage device serving as the master through a communication connection, that a battery level of a second energy storage device serving as the slave is greater than or equal to a second battery level value and a battery level of a third energy storage device serving as the slave is less than or equal to a third battery level value, the second energy storage device is controlled to charge the third energy storage device through the household grid. The second battery level value is greater than the third battery level value.

Specifically, the second battery level value may be, for example, 80%, 81%, 82%, 85%, 86%, 87%, 88%, 89%, 90%, or 100%, which is not limited herein.

The third battery level value may be, for example, 1%, 2%, 3%, 4%, 5%, 6%, 7%, 9%, 10%, or 15%, which is not limited herein.

For example, the battery level of the second energy storage device serving as slave 4 is 90%, and the battery level of the third energy storage device serving as slave 5 is 10%. In this case, the first energy storage device serving as the master may control the second energy storage device serving as slave 4 to charge the third energy storage device serving as slave 5 through the household grid.

That is, in the parallel control method of the present disclosure, the first energy storage device serving as the master may control the second energy storage device serving as the slave and having a higher battery level to perform, through the household grid, internal self-charging on the third energy storage device serving as the slave and having a lower battery level.

Although several embodiments of the present disclosure have been described above in a specific and detailed manner, the protection scope of the present disclosure shall not be construed as being limited to these embodiments. It should be noted that various variants and improvements can be made by any of those skilled in the art without departing from the concept of the present disclosure. Therefore, these variants and improvements are to be encompassed by the protection scope of present disclosure as defined by the claims as appended.

What is claimed is:

1. A household power supply network, comprising:
an energy storage device; and
a household power distribution device comprising a utility power input terminal, a household grid terminal, and a power distribution management module, wherein the utility power input terminal is configured to be connected to a utility power, wherein the household grid terminal is configured to be connected to a household grid, and wherein the household grid is connectable to one of the utility power or the energy storage device, wherein:
the power distribution management module comprises a main output line provided with a smart circuit breaker;
the smart circuit breaker comprises a control module and a main line switch electrically connected to the control module, the main line switch having an end connected to the utility power input terminal and another end connected to the household grid terminal;
the control module comprises a detection unit configured to detect whether the utility power input terminal loses power and to detect whether the energy storage device is connected to the household grid;
the control module is configured to, in response to the detection unit detecting that the utility power input terminal loses power, control the main line switch to be opened, to enable the energy storage device to supply power to the household grid; and
the control module is configured to, in response to the utility power being normal and the household grid being disconnected from the energy storage device, control the main line switch to be closed, to enable the utility power to supply power to the household grid.

2. The household power supply network according to claim 1, wherein the control module comprises:
a switch power supply having a first input terminal electrically connected to the utility power input terminal and a second input terminal electrically connected to the household grid terminal, wherein the switch power supply is capable of receiving electrical energy provided by the utility power or the household grid to drive the main line switch to be opened or closed.

3. The household power supply network according to claim 1, wherein the control module further comprises:
a switch power supply; and
a backup power supply having an end connected to the utility power input terminal and another end connected to a third input terminal of the switch power supply, wherein the backup power supply is configured to be charged by the utility power in response to the utility power being normal, and provide electrical energy to the switch power supply in response to the utility power losing power, to drive the main line switch to be opened.

4. The household power supply network according to claim 1, wherein the control module further comprises a control unit electrically connected to the detection unit,
wherein the control unit is configured to:
in response to the detection unit detecting that the utility power input terminal loses power, control the main line switch to be opened, and
in response to the detection unit detecting that the utility power being normal and the household grid being disconnected from the energy storage device, control the main line switch to be closed, to enable the utility power to supply power to the household grid.

5. The household power supply network according to claim 4, wherein:
the control module further comprises a driving unit connected to the main line switch; and
the control unit is connected to each of the detection unit and the driving unit, and is configured to, in response to the detection unit detecting that the utility power input terminal loses power and the energy storage device being connected to the household grid, control the driving unit to operate to open the main line switch, and control the energy storage device to supply power to the household grid.

6. The household power supply network according to claim 1, wherein the control module is communicatively connected to the energy storage device, and is configured to, in response to the utility power losing power and the main line switch being open, control the energy storage device to supply power to the household grid.

7. The household power supply network according to claim 1, wherein the power distribution management module further comprises:
a plurality of output branch lines electrically connected to the main output line, each of the plurality of output branch lines comprising an electrical energy input terminal, a household load access terminal, and a branch line switch, wherein the electrical energy input terminal is connected to the main line switch, and wherein the branch line switch is disposed between the electrical energy input terminal and the household load access terminal, and is configured to control a connection or a disconnection of a path between the electrical energy input terminal and the household load access terminal.

8. The household power supply network according to claim 1, further comprising:
a smart control socket disposed between the utility power and a household load and connected to the energy storage device, wherein a transfer switch is provided in the smart control socket, wherein:
the transfer switch is capable of selectively connecting the household load to the utility power or selectively connecting the household load to the energy storage device, the household load being connected to only one of the utility power or the energy storage device at any time point; and
the transfer switch is configured to, in response to the utility power being normal, connect a circuit between the utility power and the household load, and disconnect a circuit between the energy storage device and the household load, and is configured to, in response to the utility power losing power, disconnect the circuit between the utility power and the household load, and connect the circuit between the energy storage device and the household load.

9. The household power supply network according to claim 8, wherein:
the smart control socket is electrically connected to the household power distribution device; and
the power distribution management module comprises a plurality of output branch lines electrically connected to the main output line, at least one of the plurality of output branch lines being connected to the smart control socket.

10. The household power supply network according to claim 8, comprising:
a plurality of energy storage devices, each of the plurality of energy storage devices comprising an output interface, wherein the energy storage device and remaining energy storage devices of the plurality of energy storage devices are connected in parallel to the household grid through the output interfaces; the energy storage device and the remaining energy storage devices are connected in one-to-one correspondence to a plurality of smart control sockets through the output interfaces; and the energy storage device is communicatively connected to the remaining energy storage devices, wherein:
the energy storage device serving as a master is configured to control an operation mode of the energy storage device as the master based on a state of the utility power, the operation mode comprising a grid-connected mode and an off-grid mode;
when the utility power is normal, the energy storage device serving as the master operates in the grid-connected mode to output an alternating current, to allow each of the remaining energy storage devices serving as slaves to output an alternating current in a grid-connected manner, and to enable the master, the slaves, and the utility power to jointly supply power to the household grid; and
when the utility power loses power, the energy storage device serving as the master operates in the off-grid mode to output the alternating current, to allow each of the remaining energy storage devices serving as the slaves to output the alternating current in the grid-connected manner, and to enable the master and the slaves to jointly supply power to the household grid.

11. The household power supply network according to claim 10, wherein the energy storage device further comprises:
a bidirectional inverter;
a battery module electrically connected to the bidirectional inverter;
an energy storage switch disposed between the bidirectional inverter and the output interface; and
an energy storage control module communicatively connected to the bidirectional inverter and the energy storage switch, wherein:
the energy storage control module is configured to, in response to the utility power being normal, control the energy storage switch to be closed, and control the bidirectional inverter to convert a direct current outputted by the battery module into an alternating current synchronized in phase with the utility power, to enable the energy storage device to be connected to the household grid in the grid-connected manner.

12. The household power supply network according to claim 11, wherein:
the energy storage control module is configured to, in response to the utility power being normal and a battery level of the energy storage device being greater than or equal to a first predetermined threshold, control the energy storage switch to be closed, and control the bidirectional inverter to convert the direct current outputted by the battery module into the alternating current synchronized in phase with the utility power, to enable the energy storage device to supply power to the household grid; and
the energy storage control module is further configured to, in response to the utility power being normal and the battery level of the energy storage device being less than or equal to a second predetermined threshold, control the energy storage switch to be closed, and control the bidirectional inverter to be in a rectification mode, to charge the battery module by the utility power.

13. The household power supply network according to claim 11, wherein:
the energy storage control module in the master is configured to, in response to a detection by the energy storage control module in the master that a battery level of the master is lower than a predetermined battery level value, control the master to disable an output of an alternating current; and
the plurality of slaves are configured to, subsequent to the slaves detecting that the master disables the output of the alternating current, reassign logical addresses through a communication protocol to determine one of the plurality of slaves as a new master, in such a manner that the energy storage control module in the new master controls the bidirectional inverter in the new master to output an alternating current, to supply power to the household grid.

14. The household power supply network according to claim 11, wherein:
the energy storage control module in the master is configured to, in response to the utility power losing power and detecting that no voltage is present on an output interface side of the energy storage switch, determine that the household grid is in an off-grid state, and control the bidirectional inverter in the master to output an alternating current in an off-grid manner to supply power to the household grid; and
the energy storage control modules in the slaves are configured to, in response to detecting that a voltage is present on the output interface side of the energy storage switch, control each of the bidirectional inverters in the slaves to output an alternating current in a grid-connected manner, to enable the slaves to supply power to the household grid.

15. The household power supply network according to claim 11, wherein:
the energy storage control module in the master is configured to, in response to the utility power being normal and detecting that a voltage is present on an output interface side of the energy storage switch, determine that the household grid is in a grid-connected state, and control the bidirectional inverter in the master to perform an inversion to output an alternating current synchronized in phase with the utility power to supply power to the household grid; and
the energy storage control modules in the slaves are configured to, in response to a detection by the energy storage control modules in the slaves that the voltage is present on the output interface side of the energy storage switch, control the bidirectional inverters in the slaves to perform an inversion to output an alternating current synchronized in phase with the master, to enable the slaves to supply power to the household grid.

16. A parallel control method, applied in a plurality of energy storage devices, each of the plurality of energy storage devices being the energy storage device in the household power supply network according to claim 1, wherein the energy storage device comprises an output interface, the energy storage device and remaining energy storage devices of the plurality of energy storage devices are connected in parallel to the household grid through the output interfaces, and the household grid is connectable to the utility power and/or the energy storage device; the household grid is provided with a socket, and the energy storage device and the remaining energy storage devices are connected in one-to-one correspondence to a plurality of sockets through the output interfaces; and the energy storage device is communicatively connected to the remaining energy storage devices, the parallel control method comprising:
controlling, by the energy storage device serving as a master, an operation mode of the energy storage device as the master based on a state of the utility power, wherein the operation mode comprises a grid-connected mode and an off-grid mode;
in response to the utility power being normal, enabling the energy storage device serving as the master to operate in the grid-connected mode to output an alternating current, to allow each of the remaining energy storage devices serving as slaves to output an alternating current in a grid-connected manner, and to enable the master, the slaves, and the utility power to jointly supply power to the household grid; and
in response to the utility power losing power, enabling the energy storage device serving as the master to operate in the off-grid mode to output the alternating current, to allow each of the remaining energy storage devices serving as the slaves to output the alternating current in the grid-connected manner, and to enable the master and the slaves to jointly supply power to the household grid.

17. A distributed energy storage system, comprising:
a plurality of energy storage devices, each of the plurality of energy storage devices being the energy storage device in the household power supply network according to claim 1, wherein the energy storage device comprises an output interface, the plurality of energy storage devices are connected in parallel to the household grid through the output interfaces, the household grid is provided with a plurality of sockets, the plurality of energy storage devices are connected in one-to-one correspondence to the plurality of sockets through the output interfaces, and the household grid is connectable to the utility power and/or the energy storage device, wherein:
the plurality of energy storage devices are communicatively connected with each other, one of the plurality of energy storage devices serves as a master, and remaining energy storage devices of the plurality of energy storage devices serve as slaves, and the master is configured to control an operation mode of the master based on a state of the utility power, the operation mode comprising a grid-connected mode and an off-grid mode;
when the utility power is normal, the master is capable of operating in the grid-connected mode to output an alternating current, and each of the slaves outputs an alternating current in a grid-connected manner, to enable the master, the slaves, and the utility power to jointly supply power to the household grid; and
when the utility power loses power, the master is capable of operating in the off-grid mode to output the alternating current, and each of the slaves outputs the alternating current in the grid-connected manner, to enable the master and the slaves to jointly supply power to the household grid.

18. The distributed energy storage system according to claim 17, wherein the master is capable of obtaining battery levels of the slaves through a communication connection, and the master is configured to control inputs and/or outputs of the slaves based on the battery levels of the slaves.

19. The distributed energy storage system according to claim 17, further comprising:
the household power distribution device according to claim 1.

20. The distributed energy storage system according to claim 19, wherein the energy storage device further comprises:
an energy storage switch; and
an energy storage control module communicatively connected to the energy storage switch, wherein:
the control module is configured to, in response to the utility power being restored subsequent to a power outage and in response to detecting that a current is present on each of a first end of the main line switch connected to the utility power and a second end of the main line switch connected to the energy storage device, notify the energy storage device through communication to stop outputting the alternating current;
the control module is further configured to, in response to the energy storage device stopping outputting the alternating current and in response to detecting that no voltage is present on the second end of the main line switch, control the main line switch to be closed; and
the energy storage control module is configured to, subsequent to the main line switch being closed, control the energy storage switch to be closed, to enable the plurality of energy storage devices to be connected to the household grid in a grid-connected manner.
